(19) United States
(12) Patent Application Publication
(10) Pub. No.: US 2026/0308318 A1
(43) Pub. Date: Oct. 8, 2026

(54) POLYCARBONATE-BASED RESIN COMPOSITION AND MOLDED ARTICLE

(71) Applicant: IDEMITSU KOSAN CO.,LTD., Tokyo (JP)

(72) Inventors: Yuki OGUSA, Chiyoda-ku, Tokyo (JP); Daisuke YOSHIZAWA, Chiyoda-ku, Tokyo (JP); Yasuhiro ISHIKAWA, Chiyoda-ku, Tokyo (JP)

(73) Assignee: IDEMITSU KOSAN CO.,LTD., Tokyo (JP)

(21) Appl. No.: 19/478,756

(22) PCT Filed: Apr. 25, 2024
(86) PCT No.: PCT/JP2024/016335

§ 371 Date: Oct. 24, 2025

(30) Foreign Application Priority Data
Apr. 28, 2023 (JP) 2023-075108

(51) Int. Cl. C08G 64/06; C08G 64/28; C08K 5/3475; C08K 5/42; C08K 5/523; C08K 7/14; C08L 69/00

(52) U.S. Cl. CPC C08G 64/06; C08G 64/28; C08K 5/3475; C08K 5/42; C08K 5/523; C08K 7/14; C08L 69/00

(57) ABSTRACT

The present invention relates to a polycarbonate-based resin composition and a molded article each including: an aromatic polycarbonate-based resin including a structural unit represented by the following formula (II); and at least one kind selected from the group consisting of: a UV absorber; a flame retardant; a polystyrene-based resin; a polyester-based resin; and an inorganic filler.

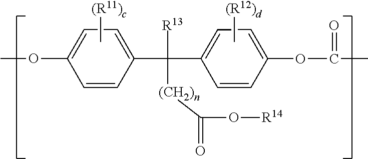

### TECHNICAL FIELD

The present invention relates to a polycarbonate-based resin composition and a molded article.

### BACKGROUND ART

A polycarbonate-based resin is excellent in, for example, impact resistance, transparency, heat resistance, and self-extinguishing property, and hence has been widely utilized as an engineering plastic in various fields, such as an electrical and electronic equipment field, and an automotive field. However, the polycarbonate-based resin has low surface hardness, and is hence insufficient in scratch resistance in some cases.

In PTL 1, as a polycarbonate copolymer having improved scratch resistance, there is a disclosure of a polycarbonate copolymer including: a unit derived from a hydroxy-terminated monocyclic, polycyclic, or fused cyclic compound having a (meth)acrylate group; and a carbonate unit.

In PTL 2, there are disclosures of a fire-resistant polycarbonate resin, which is branched or crosslinked, and an intermediate thereof.

### CITATION LIST

### Patent Literature

PTL 1: KR 2016-0141268 A
PTL 2: JP H02-219818 A

### SUMMARY OF INVENTION

### Technical Problem

A method including coating the surface of the uppermost layer of a structural body formed of a polycarbonate-based resin has been known as a method of improving the surface hardness thereof. However, there is a problem in that a coating step is required, and hence a production process becomes complicated and an environmental load becomes larger.

Further, the invention described in PTL 1 is insufficient in surface hardness. In PTL 2, there is no description of a method of improving the surface hardness.

As described above, a further investigation has been required to achieve both of scratch resistance and any other effect with the polycarbonate-based resin alone.

An object of the present invention is to provide a polycarbonate-based resin composition and a molded article each of which is improved in surface hardness without impairment of its appearance, is improved in scratch resistance, and is improved in at least one of weatherability, flame retardancy, fluidity, tensile characteristic, chemical resistance, or rigidity.

### Solution to Problem

The inventors of the present invention have found that the above-mentioned problems are solved by an aromatic polycarbonate-based resin including a specific structural unit.

That is, the present invention encompasses the following items 1 to 11.

1. A polycarbonate-based resin composition, including:
an aromatic polycarbonate-based resin including a structural unit represented by the following formula (II); and
at least one kind selected from the group consisting of: a UV absorber; a flame retardant; a polystyrene-based resin; a polyester-based resin; and an inorganic filler:

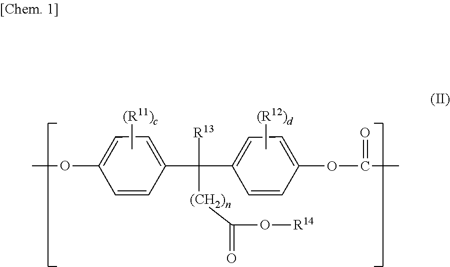

wherein in the formula (II),
R¹¹ and R¹² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
R¹³ represents a hydrogen atom, or a group selected from the group consisting of: an alkyl group having 1 to 5 carbon atoms; a cycloalkyl group having 3 to 20 carbon atoms; a cycloalkoxy group having 3 to 20 carbon atoms; an alkenyl group having 2 to 10 carbon atoms; and an aryl group having 6 to 14 carbon atoms,
R¹⁴ represents a saturated or unsaturated alicyclic group having 3 to 20 carbon atoms, or a 3- to 20-membered saturated or unsaturated heterocyclic group,
“c” and “d” each independently represent an integer of from 0 to 4, and
“n” represents an integer of from 0 to 20.

2. The polycarbonate-based resin composition according to Item 1, wherein R¹⁴ represents a saturated or unsaturated alicyclic group having 3 to 12 carbon atoms, or a 3- to 12-membered saturated or unsaturated heterocyclic group.

3. The polycarbonate-based resin composition according to Item 2, wherein R¹⁴ represents a cyclopentyl group or a cyclohexyl group.

4. The polycarbonate-based resin composition according to any one of Items 1 to 3, wherein “n” represents an integer of from 0 to 4.

5. The polycarbonate-based resin composition according to any one of Items 1 to 4, wherein the UV absorber includes at least one kind selected from the group consisting of: a benzotriazole-based UV absorber; a benzoxazinone-based UV absorber; a salicylate-based UV absorber; a malonic acid ester-based UV absorber; an oxalic anilide-based UV absorber; a triazine-based UV absorber; a benzophenone-based UV absorber; and a cyanoacrylate-based UV absorber.

6. The polycarbonate-based resin composition according to any one of Items 1 to 4, wherein the flame retardant includes at least one kind selected from the group consisting of: a phosphorus-based flame retardant; and a metal salt-based flame retardant.

7. The polycarbonate-based resin composition according to any one of Items 1 to 4, wherein the polystyrene-based resin includes at least one kind selected from the group consisting of: a high impact polystyrene resin; an acrylonitrile-styrene copolymer; an acrylonitrile-butadiene-styrene copolymer; a methyl methacrylate-styrene copolymer; a methyl methacrylate-butadiene-styrene copolymer; an acrylonitrile-methyl acrylate-styrene copolymer; and an acrylonitrile-(ethylene/propylene/diene copolymer)-styrene copolymer.

8. The polycarbonate-based resin composition according to any one of Items 1 to 4, wherein the polyester-based resin includes at least one kind selected from the group consisting of: polyethylene terephthalate; polybutylene terephthalate; polyethylene naphthalate; and polybutylene naphthalate.

9. The polycarbonate-based resin composition according to any one of Items 1 to 4, wherein the inorganic filler is a glass filler.

10. The polycarbonate-based resin composition according to any one of Items 1 to 9, further including a repeating unit represented by the following formula (I):

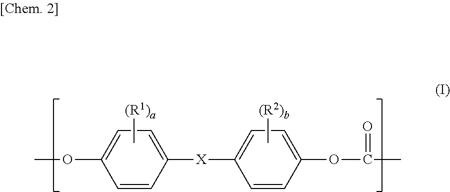

wherein in the formula (I),
R¹ and R² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an aralkyl group having 7 to 20 carbon atoms, —S—, —SO—, —SO₂—, —O—, or —CO—, and “a” and “b” each independently represent an integer of from 0 to 4.

11. A molded article of the polycarbonate-based resin composition of any one of Items 1 to 10.

### Advantageous Effects of Invention

The present invention can provide the polycarbonate-based resin composition and the molded article each of which is improved in scratch resistance and is improved in at least one of weatherability, flame retardancy, fluidity, tensile characteristic, chemical resistance, or rigidity.

### DESCRIPTION OF EMBODIMENTS

A polycarbonate-based resin composition and a molded article of the present invention are described in detail below. In this description, a specification considered to be preferred may be arbitrarily adopted, and it can be said that a combination of preferred specifications is more preferred. The term “XX to YY” as used herein means “XX or more and YY or less.”

### 1. Aromatic Polycarbonate-Based Resin

The polycarbonate-based resin composition of the present invention includes an aromatic polycarbonate-based resin including a structural unit represented by the following formula (II):

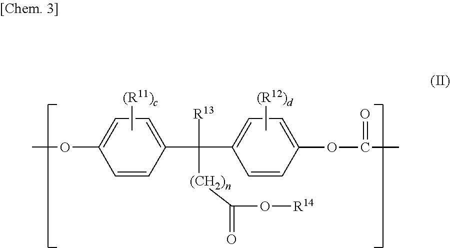

wherein in the formula (II),
R¹¹ and R¹² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 6 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
R¹³ represents a hydrogen atom, or a group selected from the group consisting of: an alkyl group having 1 to 5 carbon atoms; a cycloalkyl group having 3 to 20 carbon atoms; a cycloalkoxy group having 3 to 20 carbon atoms; an alkenyl group having 2 to 10 carbon atoms; and an aryl group having 6 to 14 carbon atoms,
R¹⁴ represents a saturated or unsaturated alicyclic group having 3 to 20 carbon atoms, or a 3- to 20-membered saturated or unsaturated heterocyclic group,
“c” and “d” each independently represent an integer of from 0 to 4, and
“n” represents an integer of from 0 to 20.

Examples of the halogen atom that R¹¹ and R¹² in the formula (II) each independently represent include a fluorine atom, a chlorine atom, a bromine atom, and an iodine atom.

Examples of the alkyl group that R¹¹ and R¹² each independently represent include a methyl group, an ethyl group, a n-propyl group, an isopropyl group, various butyl groups (the term “various” means that a linear group and all kinds of branched groups are included, and the same holds true for the following), various pentyl groups, and various hexyl groups.

Examples of the alkoxy group that R¹¹ and R¹² each independently represent include alkoxy groups whose alkyl group moieties are the above-mentioned alkyl groups.

Examples of the cycloalkyl group that R¹¹ and R¹² each independently represent include a cyclopropyl group, a cyclobutyl group, a cyclopentyl group, a cyclohexyl group, and a cycloheptyl group.

Examples of the cycloalkyl group that R¹¹ and R¹² each independently represent include cycloalkoxy groups whose cycloalkyl group moieties are the above-mentioned cycloalkyl groups.

Examples of the alkenyl group that R¹¹ and R¹² each independently represent include an ethenyl group, a propenyl group, a butenyl group, a pentenyl group, and a hexenyl group.

Examples of the aryl group that R¹¹ and R¹² each independently represent include a phenyl group, a naphthyl group, a biphenyl group, and an anthryl group.

Examples of the aryloxy group that R¹¹ and R¹² each independently represent include aryloxy groups whose aryl group moieties are the above-mentioned aryl groups.

Examples of the aralkyl group that R¹¹ and R¹² each independently represent include a phenylmethyl group and a phenylethyl group.

Examples of the aralkyloxy group that R¹¹ and R¹² each independently represent include aralkyloxy groups whose aralkyl group moieties are the above-mentioned aralkyl groups.

Examples of the alkyl group represented by R¹³ in the formula (II) include a methyl group, an ethyl group, a n-propyl group, an isopropyl group, various butyl groups, and various pentyl groups.

Examples of the cycloalkyl group represented by R¹³ include a cyclopropyl group, a cyclobutyl group, a cyclopentyl group, a cyclohexyl group, and a cycloheptyl group.

Examples of the cycloalkoxy group represented by R¹³ include cycloalkoxy groups whose cycloalkyl group moieties are the above-mentioned cycloalkyl groups.

Examples of the alkenyl group represented by R¹³ include an ethenyl group, a propenyl group, a butenyl group, a pentenyl group, and a hexenyl group.

Examples of the aryl group represented by R¹³ include a phenyl group, a naphthyl group, a biphenyl group, and an anthryl group.

The saturated or unsaturated alicyclic group represented by R¹⁴ in the formula (II) has 3 to 20 carbon atoms, preferably 3 to 12 carbon atoms, more preferably 4 to 8 carbon atoms. Specific examples thereof include: cycloalkyl groups serving as saturated alicyclic groups, such as a cyclopropyl group, a cyclobutyl group, a cyclopentyl group, a cyclohexyl group, a cycloheptyl group, an adamantyl group, and a norbornyl group; and cycloalkenyl groups serving as unsaturated alicyclic groups, such as a cyclopropenyl group, a cyclobutenyl group, a cyclopentenyl group, a cyclohexenyl group, and a cycloheptenyl group. The unsaturated alicyclic group is free of an aromatic group.

The number of atoms for forming the ring of the heterocyclic group represented by R¹⁴ is from 3 to 20, and the ring has preferably 3 to 12 carbon atoms, more preferably 3 to 8 carbon atoms. The heterocyclic group is a cyclic group containing at least one heteroatom, for example, one, two, or three heteroatoms as ring-forming atoms. Specific examples of the heteroatom include a nitrogen atom, an oxygen atom, a sulfur atom, a silicon atom, a phosphorus atom, and a boron atom.

Examples of the heterocyclic group include a pyridinyl group, a pyrazinyl group, a pyrimidinyl group, a pyridazinyl group, a triazinyl group, an indolinyl group, a quinolinyl group, an acridinyl group, a pyrrolidinyl group, a dioxanyl group, a piperidinyl group, an oxiranyl group (epoxy group), an oxetanyl group, a morpholidinyl group, a piperazinyl group, a carbazolyl group, a furanyl group, a thiophenyl group, an oxazolyl group, an oxadiazolyl group, a benzoxazolyl group, a thiazolyl group, a thiadiazolyl group, a benzothiazolyl group, a triazolyl group, an imidazolyl group, a benzimidazolyl group, and a furanyl group.

R¹⁴ represents preferably a saturated or unsaturated alicyclic group having 3 to 12 carbon atoms, or a 3- to 12-membered saturated or unsaturated heterocyclic group, more preferably a cycloalkyl group having 3 to 8 carbon atoms, still more preferably a cyclopentyl group or a cyclohexyl group.

“c” and “d” each independently represent an integer of from 0 to 4, preferably an integer of from 0 to 2, more preferably 0 or 1.

“n” represents an integer of from 0 to 20, preferably an integer of from 0 to 10, more preferably an integer of from 0 to 4, still more preferably 0, 1, 2, 3, or 4, still more preferably 2.

As another aspect, “n” represents preferably an integer of from 1 to 10, more preferably an integer of from 1 to 4.

In a preferred aspect of the formula (II), from the viewpoint of improving the scratch resistance of the resin composition, R¹⁴ represents a cyclopentyl group or a cyclohexyl group, and “n” represents preferably from 0 to 2, more preferably 2. In addition, “c” and “d” each preferably represent 0, and R¹³ represents preferably an alkyl group having 1 to 3 carbon atoms, more preferably a methyl group.

In the aromatic polycarbonate-based resin, the structural units each represented by the formula (II) may be used alone or in combination thereof.

The aromatic polycarbonate-based resin may further include a repeating unit represented by the following formula (I):

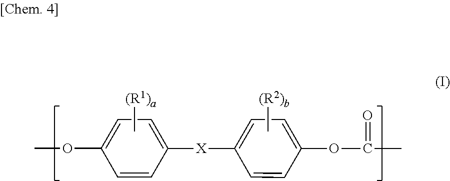

wherein in the formula (I),
R¹ and R² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an aralkyl group having 7 to 20 carbon atoms, —S—, —SO—, —SO₂—, —O—, or —CO—, and “a” and “b” each independently represent an integer of from 0 to 4.

Examples of the halogen atom that R¹ and R² in the formula (I) each independently represent include a fluorine atom, a chlorine atom, a bromine atom, and an iodine atom.

Examples of the alkyl group that R¹ and R² each independently represent include a methyl group, an ethyl group, a n-propyl group, an isopropyl group, various butyl groups, various pentyl groups, and various hexyl groups.

Examples of the alkoxy group that R¹ and R² each independently represent include alkoxy groups whose alkyl group moieties are the above-mentioned alkyl groups.

Examples of the cycloalkyl group that R¹ and R² each independently represent include a cyclopropyl group, a cyclobutyl group, a cyclopentyl group, a cyclohexyl group, and a cycloheptyl group.

Examples of the cycloalkyl group that R¹ and R² each independently represent include cycloalkoxy groups whose cycloalkyl group moieties are the above-mentioned cycloalkyl groups.

Examples of the alkenyl group that R¹ and R² each independently represent include an ethenyl group, a propenyl group, a butenyl group, a pentenyl group, and a hexenyl group.

Examples of the aryl group that R¹ and R² each independently represent include a phenyl group, a naphthyl group, a biphenyl group, and an anthryl group.

Examples of the aryloxy group that R¹ and R² each independently represent include aryloxy groups whose aryl group moieties are the above-mentioned aryl groups.

Examples of the aralkyl group that R¹ and R² each independently represent include a phenylmethyl group and a phenylethyl group.

Examples of the aralkyloxy group that R¹ and R² each independently represent include aralkyloxy groups whose aralkyl group moieties are the above-mentioned aralkyl groups.

The alkylene group represented by X has 1 to 8 carbon atoms, preferably 1 to 5 carbon atoms. Specific examples thereof include a methylene group, an ethylene group, a trimethylene group, a tetramethylene group, and a hexamethylene group.

Examples of the alkylidene group represented by X include an ethylidene group and an isopropylidene group.

The cycloalkylene group represented by X has 5 to 15 carbon atoms, preferably 5 to 10 carbon atoms. Specific examples thereof include a cyclopentanediyl group, a cyclohexanediyl group, and a cyclooctanediyl group.

Examples of the arylene group represented by X include a phenylene group, a naphthylene group, a biphenylene group, and a tetraphenyl group.

The cycloalkylidene group represented by X has 5 to 15 carbon atoms, preferably 5 to 10 carbon atoms. Specific examples thereof include a cyclohexylidene group, a 3,5,5-trimethylcyclohexylidene group, and a 2-adamantylidene group.

Examples of the aryl moiety of the aralkyl group (arylalkylene group) represented by X include aryl groups each having 6 to 14 ring-forming carbon atoms, such as a phenyl group, a naphthyl group, a biphenyl group, and an anthryl group.

A case in which X represents an isopropylidene group, a cyclohexylidene group, or a 3,5,5-trimethylcyclohexylidene group among those described above is preferred from the viewpoint that a molded article of the aromatic polycarbonate-based resin is improved in scratch resistance.

“a” and “b” each independently represent an integer of from 0 to 4, preferably from 0 to 2, more preferably 0 or 1.

Among them, a case in which “a” and “b” each represent 0, and X represents a single bond or an alkylene group having 1 to 8 carbon atoms, or a case in which “a” and “b” each represent 0, and X represents an alkylidene group, in particular, an isopropylidene group is suitable.

In addition, as another aspect, a case in which “a” and “b” each represent 1, and X represents a single bond or an alkylene group having 1 to 8 carbon atoms, or a case in which “a” and “b” each represent 1, and X represents an alkylidene group, in particular, an isopropylidene group is preferred from the viewpoint that the molded article of the aromatic polycarbonate-based resin is improved in scratch resistance.

Specific examples of the repeating unit represented by the formula (I) include repeating units represented by the following general formulae (I-i) to (I-iv).

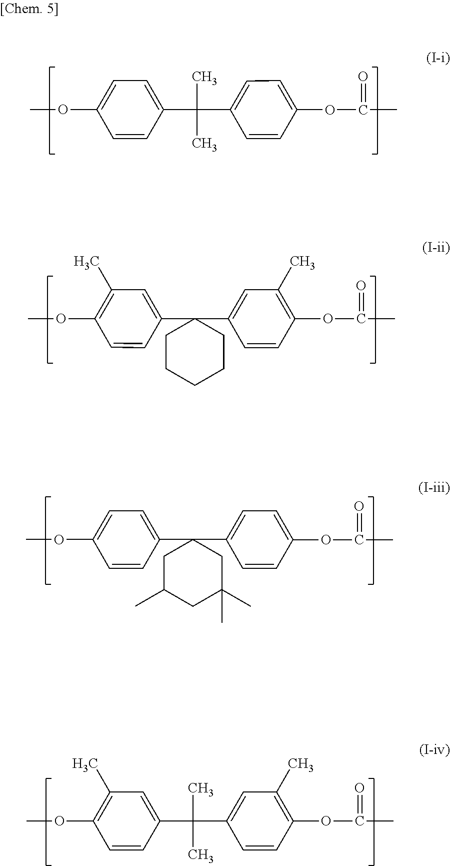

In the aromatic polycarbonate-based resin, the repeating units each represented by the formula (I) may be used alone or in combination thereof. Specifically, for example, the following aspects are given: an aspect in which the resin is formed only of the repeating unit represented by the general formula (I-i); and an aspect in which the resin is formed of a combination of the repeating unit represented by the general formula (I-i), and one or more kinds selected from the group consisting of the repeating units represented by the general formulae (I-ii) to (I-iv). Such aromatic polycarbonate-based resin may be easily produced by an interfacial polymerization method in which a polycarbonate oligomer to be described later is produced in advance.

When the above-mentioned aromatic polycarbonate-based resin includes the repeating unit represented by the formula (I), the aromatic polycarbonate-based resin is an aromatic polycarbonate-based copolymer including the repeating unit represented by the formula (I) and the structural unit represented by the formula (II).

In the above-mentioned aromatic polycarbonate-based resin, a molar ratio ((I):(II)) between the repeating unit represented by the formula (I) and the structural unit represented by the formula (II) is preferably from 0:100 to 99.5:0.5, more preferably from 0.5:99.5 to 99.5:0.5, still more preferably from 0.5:99.5 to 99:1, still further more preferably from 0.5:99.5 to 94:6, most preferably from 0.5:99.5 to 92:8.

The molar ratio ((I):(II)) between the repeating unit represented by the formula (I) and the structural unit represented by the formula (II) is preferably from 60:40 to 99.5:0.5, more preferably from 70:30 to 99:1, still more preferably from 80:20 to 98:2 among those molar ratios.

The molar ratio between the repeating unit represented by the formula (I) and the structural unit represented by the formula (II) in the aromatic polycarbonate-based resin is calculated by nuclear magnetic resonance (NMR) measurement. Specifically, 1H-NMR measurement is performed, and the ratio is calculated from the integrated values of a peak derived from the repeating unit represented by the formula (I) and a peak derived from the structural unit represented by the formula (II).

The aromatic polycarbonate-based resin of the present invention may include a constituent unit except the repeating unit represented by the formula (I) and the structural unit represented by the formula (II). Examples of such unit include a terminal structure derived from a terminal stopper to be described later and a silicon atom-containing constituent unit.

The viscosity-average molecular weight of the above-mentioned aromatic polycarbonate-based resin is preferably from 10,000 to 100,000, more preferably from 10,000 to 80,000, still more preferably from 15,000 to 30,000, still more preferably from 17,000 to 25,000 in terms of its mechanical characteristics and moldability.

In the present invention, the viscosity-average molecular weight (Mv) is calculated from the following Schnell's equation after the determination of a limiting viscosity [η] through the measurement of the viscosity of a methylene chloride solution (concentration: g/L) at 20° C. with an Ubbelohde-type viscometer.

$$[ η ] = 1.23 \times {10}^{- 5} {Mv}^{0.83}$$

The molded article of the aromatic polycarbonate-based resin of the present invention is improved in scratch resistance.

The scratch resistance may be evaluated by scratch hardness (pencil method). The scratch hardness (pencil method) of the molded article of the above-mentioned aromatic polycarbonate-based resin evaluated in conformity with JIS K5600 May 4:1999 is preferably HB or more.

### 2. Method of Producing Aromatic Polycarbonate-Based Resin

### (Dihydric Phenol-Based Compound)

The above-mentioned aromatic polycarbonate-based resin may be suitably produced by using a dihydric phenol-based compound (a) represented by the following formula (ii). The structural unit represented by the formula (II) of the above-mentioned aromatic polycarbonate-based resin is derived from the dihydric phenol-based compound (a).

Accordingly, the present invention also provides a use of the dihydric phenol-based compound (a) represented by the following formula (ii) for production of an aromatic polycarbonate-based resin:

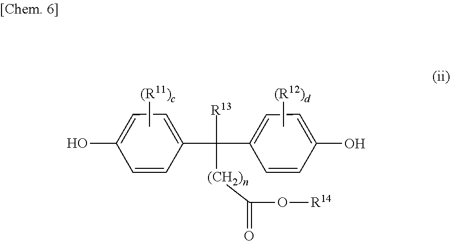

wherein in the formula (ii), R¹¹, R¹², R¹³, R¹⁴, “c”, “d”, and “n” are as defined above, and preferred examples thereof are also the same as those described above.

Preferred specific examples of the dihydric phenol-based compound (a) include cyclohexyl diphenolate represented by the following formula (ii-1), cyclopentyl diphenolate represented by the following formula (ii-2), and cyclohexyl 2,2-bis(4-hydroxyphenyl) propanoate represented by the following formula (ii-3).

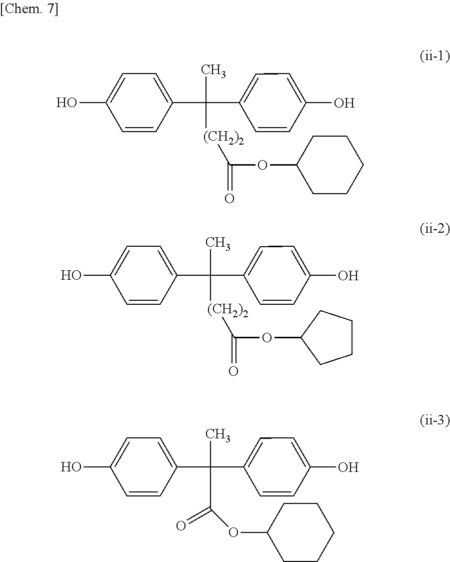

The dihydric phenol-based compound (a) may be produced by, for example, causing a carboxylic acid compound (a-x) represented by the following formula (ii-x) and an alcohol compound (a-y) represented by the following formula (ii-y) to react with each other in the presence of an acid catalyst as required:

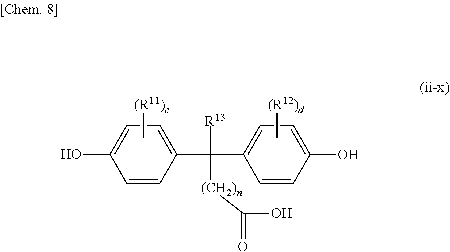

wherein in the formula (ii-x), R¹¹, R¹², R¹³, “c”, “d”, and “n” are as defined above, and preferred examples thereof are also the same as those described above;

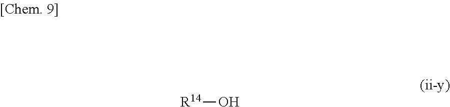

wherein in the formula (ii-y), R¹⁴ is as defined above, and preferred examples thereof are also the same as those described above.

### (Method of Producing Aromatic Polycarbonate-Based Resin)

The above-mentioned aromatic polycarbonate-based resin may be produced by a known method of producing a polycarbonate-based resin as long as the dihydric phenol-based compound (a) represented by the formula (ii) is used as the dihydric phenol-based compound. Examples of the method of producing a polycarbonate-based resin include:
(i) an interfacial polymerization method (phosgene method) including causing the dihydric phenol-based compound and phosgene to react with each other in the presence of an organic solvent inert to the reaction and an aqueous alkali solution, and then adding a polymerization catalyst, such as a tertiary amine or a quaternary ammonium salt, to polymerize the resultant;
(ii) a melt polymerization method (ester exchange method) including subjecting the dihydric phenol-based compound and a carbonic acid diester to an ester exchange reaction under a molten state in which no solvent is used through the addition of a basic catalyst; and
(iii) a pyridine method including dissolving the dihydric phenol-based compound in pyridine or a mixed solution containing pyridine and an inert solvent, and introducing phosgene into the solution to directly produce the resin.

A molecular weight modifier (terminal stopper), a branching agent, or the like is used as required in the above-mentioned reaction.

Among them, the following production method is preferred:
a method of producing an aromatic polycarbonate-based resin, including a step of subjecting the dihydric phenol-based compound and a polycarbonate oligomer to interfacial polycondensation in the presence of a water-insoluble organic solvent and an aqueous solution of an alkali compound, wherein the dihydric phenol-based compound includes the dihydric phenol-based compound (a) represented by the formula (ii).

Specifically, in the case of the above-mentioned interfacial polymerization method, the above-mentioned polycarbonate-based resin may be produced by: dissolving a polycarbonate oligomer produced in advance to be described later in a water-insoluble organic solvent (e.g., methylene chloride); adding a solution of a dihydric phenol-based compound in an aqueous solution of an alkali compound (e.g., aqueous sodium hydroxide) to the solution; and subjecting the mixture to an interfacial polycondensation reaction through use of a tertiary amine (e.g., triethylamine) or a quaternary ammonium salt (e.g., trimethylbenzylammonium chloride) as a polymerization catalyst in the presence of a terminal stopper (a monohydric phenol such as p-tert-butylphenol) as required. In addition, in the case of the above-mentioned interfacial polymerization method, the above-mentioned aromatic polycarbonate-based resin may be produced by copolymerizing a dihydric phenol and phosgene, a carbonic acid ester, or a chloroformate.

The polycarbonate oligomer may be produced by a reaction between a dihydric phenol-based compound and a carbonate precursor, such as phosgene or triphosgene, in an organic solvent, such as methylene chloride, chlorobenzene, or chloroform. When the polycarbonate oligomer is produced by using an ester exchange method, the oligomer may be produced by a reaction between the dihydric phenol-based compound and a carbonate precursor such as diphenyl carbonate.

The dihydric phenol contains the dihydric phenol-based compound (a) represented by the following formula (ii) from which the structural unit represented by the formula (II) is derived. The dihydric phenol preferably further contains a dihydric phenol-based compound (b) represented by the following formula (i) from which the repeating unit represented by the formula (I) is derived.

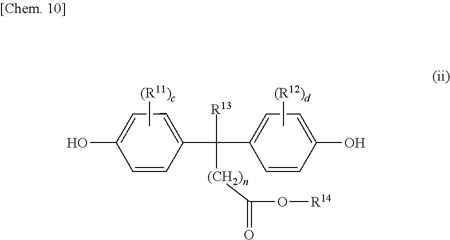

wherein in the formula (ii), R¹¹, R¹², R¹³, R¹⁴, “c”, “d”, and “n” are as defined above, and preferred examples thereof are also the same as those described above.

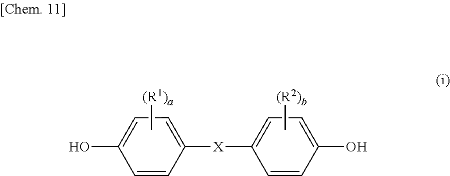

wherein in the formula (i), R¹, R², X, “a”, and “b” are as defined above, and preferred examples thereof are also the same as those described above.

Examples of the dihydric phenol-based compound (b) include: bis(hydroxyphenyl)alkane-based, such as 2,2-bis(4-hydroxyphenyl)propane [bisphenol A (BPA)], bis(4-hydroxyphenyl)methane, 1,1-bis(4-hydroxyphenyl)ethane, and 2,2-bis(4-hydroxy-3,5-dimethylphenyl)propane; 4,4′-dihydroxydiphenyl; bis(4-hydroxyphenyl)cycloalkanes; bis(4-hydroxyphenyl)oxide; bis(4-hydroxyphenyl)sulfide; bis(4-hydroxyphenyl)sulfone; bis(4-hydroxyphenyl)sulfoxide; and bis(4-hydroxyphenyl) ketone. Those dihydric phenol-based compounds may be used alone or as a mixture thereof.

Among them, bis(hydroxyphenyl)alkane-based dihydric phenols are preferred, and bisphenol A is more preferred.

In a preferred production method, only the above-mentioned dihydric phenol-based compound (b) may be used as a dihydric phenol-based compound for producing the above-mentioned polycarbonate oligomer. In this case, in the step of the interfacial polycondensation reaction, the above-mentioned dihydric phenol-based compound (a) and the above-mentioned dihydric phenol-based compound (b) are used in combination, or only the above-mentioned dihydric phenol-based compound (a) is used.

A terminal stopper (molecular weight modifier) may be used for adjusting the molecular weight of the aromatic polycarbonate-based resin to be obtained. Examples of the terminal stopper may include monohydric phenols, such as phenol, p-cresol, p-tert-butylphenol, p-tert-octylphenol, p-cumylphenol, p-nonylphenol, m-pentadecylphenol, and p-tert-amylphenol. Those monohydric phenols may be used alone or in combination thereof.

### 3. Polycarbonate-Based Resin Composition

The polycarbonate-based resin composition of the present invention includes: the above-mentioned aromatic polycarbonate-based resin; and at least one kind selected from the group consisting of: a UV absorber; a flame retardant; a polystyrene-based resin; a polyester-based resin; and an inorganic filler.

### (UV Absorber)

When the polycarbonate-based resin composition of the present invention includes: the above-mentioned aromatic polycarbonate-based resin and the UV absorber, the following effects are exhibited: the polycarbonate-based resin composition and the molded article thereof are each improved in scratch resistance and weatherability.

When the polycarbonate-based resin composition includes the UV absorber, the composition preferably includes 0.01 part by mass to 3.0 parts by mass of the UV absorber with respect to 100 parts by mass of the aromatic polycarbonate-based resin. When the content of the UV absorber is 0.01 part by mass or more, the weatherability of the molded article to be obtained can be further improved. When the content of the UV absorber is 3.0 parts by mass or less, mold adhesion at the time of the molding of the resin composition can be further suppressed.

From the viewpoint of further improving the weatherability, the content of the UV absorber in the polycarbonate-based resin composition is preferably 0.05 part by mass or more, more preferably 0.10 part by mass or more, still more preferably 0.15 part by mass or more, still more preferably 0.20 part by mass or more, still more preferably 0.25 part by mass or more with respect to 100 parts by mass of the aromatic polycarbonate-based resin. From the viewpoint of further suppressing mold adhesion at the time of the molding of the resin composition, the content is preferably 2.0 parts by mass or less, more preferably 1.0 part by mass or less, still more preferably 0.50 part by mass or less, still more preferably 0.35 part by mass or less. In addition, the content of the UV absorber in the polycarbonate-based resin composition is preferably from 0.05 part by mass to 2.0 parts by mass, more preferably from 0.10 part by mass to 1.0 part by mass, still more preferably from 0.15 part by mass to 0.50 part by mass, still more preferably from 0.20 part by mass to 0.35 part by mass, still more preferably from 0.25 part by mass to 0.35 part by mass with respect to 100 parts by mass of the aromatic polycarbonate-based resin.

The polycarbonate-based resin composition according to the present invention may include one kind or two or more kinds of UV absorbers.

The UV absorber is, for example, at least one kind selected from the group consisting of: a benzotriazole-based UV absorber; a benzoxazinone-based UV absorber; a salicylate-based UV absorber; a malonic acid ester-based UV absorber; an oxalic anilide-based UV absorber; a triazine-based UV absorber; a benzophenone-based UV absorber; and a cyanoacrylate-based UV absorber. Those UV absorbers may be used alone or in combination thereof. From the viewpoint of the weatherability, the UV absorber preferably includes at least one kind selected from the group consisting of: a benzotriazole-based UV absorber; and a benzoxazinone-based UV absorber, is more preferably at least one kind selected from the group consisting of: a benzotriazole-based UV absorber; and a benzoxazinone-based UV absorber, and is still more preferably a benzotriazole-based UV absorber.

Examples of the benzotriazole-based UV absorber include 2-(5-methyl-2-hydroxyphenyl)benzotriazole, 2-(2-hydroxy-4-octyloxyphenyl)benzotriazole, 2-[2-hydroxy-3,5-bis(α,α-dimethylbenzyl)phenyl]-2H-benzotriazole, 2-(3,5-di-tert-butyl-2-hydroxyphenyl)benzotriazole, 2-(3-tert-butyl-5-methyl-2-hydroxyphenyl)-5-chlorobenzotriazole, 2-(3,5-di-tert-butyl-2-hydroxyphenyl)-5-chlorobenzotriazole, 2-(3,5-di-tert-amyl-2-hydroxyphenyl)benzotriazole, 2-(2′-hydroxy-5′-tert-octylphenyl)benzotriazole, 2-[2-hydroxy-3-(3,4,5,6-tetra-hydrophthalimidomethyl)-5-methylphenyl]benzotriazole, 2,2′-methylenebis[4-(1,1,3,3-tetramethylbutyl)-6-(2H-benzotriazol-2-yl) phenol], and a condensate of methyl-3-[3-tert-butyl-5-(2H-benzotriazol-2-yl)-4-hydroxyphenyl]propionate and polyethylene glycol (molecular weight: about 300).

Among them, 2-[2-hydroxy-3,5-bis(α,α-dimethylbenzyl)phenyl]-2H-benzotriazole, 2-(2′-hydroxy-5′-tert-octylphenyl)benzotriazole, or 2,2′-methylenebis[4-(1,1,3,3-tetramethylbutyl)-6-(2H-benzotriazol-2-yl) phenol] is preferred, and 2,2′-methylenebis[4-(1,1,3,3-tetramethylbutyl)-6-(2H-benzotriazol-2-yl) phenol] is more preferred. Those benzotriazole-based UV absorbers may be used alone or as a mixture thereof.

An example of the benzoxazinone-based compound may be a compound represented by the following general formula (1):

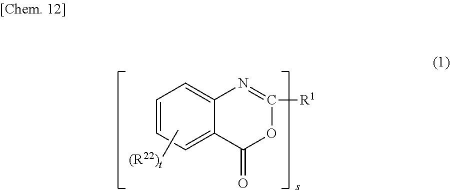

wherein R²¹ represents a residue obtained by removing “s” hydrogen atoms from a hydrocarbon compound having one or two aromatic rings in a molecule thereof, R²² represents hydrogen, a halogen group, a nitro group, an alkyl group having 1 to 8 carbon atoms, an alkoxyl group having 1 to 8 carbon atoms, or an alkenyloxy group having 2 to 8 carbon atoms, “s” represents an integer of 2 or 3, and “t” represents an integer of from 1 to 4.

In the general formula (1), R²¹ represents a residue obtained by removing “s” hydrogen atoms from a hydrocarbon compound having one or two aromatic rings in a molecule thereof, and examples thereof may include arylene groups, such as a phenylene group, a biphenylene group, and a naphthylene group. In R²², examples of the alkyl group having 1 to 8 carbon atoms may include a methyl group, an ethyl group, a propyl group, and a butyl group, examples of the alkoxyl group having 1 to 8 carbon atoms may include a methoxy group, an ethoxy group, a propoxy group, and a butoxy group, and examples of the alkenyloxy group having 2 to 8 carbon atoms may include an allyloxy group, a 2-propenyloxy group, a 2-butenyloxy group, and a 2-methyl-3-propenyloxy group.

Among the compounds each represented by the general formula (1), 2,2′-(1,4-phenylene)bis(4H-3,1-benzoxazin-4-one) [p-phenylenebis(1,3-benzoxazin-4-one)] is preferred. 2,2′-(1,4-Phenylene)bis(4H-3,1-benzoxazin-4-one) is a compound represented by the following formula.

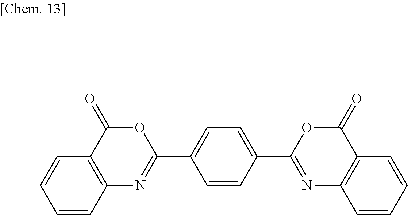

Examples of the salicylate-based UV absorber include phenyl salicylate, p-tert-butylphenyl salicylate, and p-octylphenyl salicylate. Examples of the malonic acid ester-based UV absorber include benzylidene bisdiethyl malonate, 4-methoxyphenyl-methylene-dimethyl ester, and tetraethyl-2,2′-(1,4-phenylene-dimethylidene)-bismalonate. An example of the oxalic anilide-based UV absorber is an oxalic anilide compound having a hydrocarbon group having 1 to 12 carbon atoms. In addition, an example of the triazine-based UV absorber is 2,4-diphenyl-6-(2-hydroxy-4-hexyloxyphenyl)-s-triazine.

From the viewpoint of further improving the balance between a tensile characteristic and weatherability, the total content of the aromatic polycarbonate-based resin and the UV absorber in the polycarbonate-based resin composition according to the present invention is preferably 50 mass % or more, more preferably 60 mass % or more, still more preferably 70 mass % or more, still more preferably 80 mass % or more, still more preferably 90 mass % or more, still more preferably 95 mass % or more, still more preferably 98 mass % or more, still more preferably 99 mass % or more with respect to 100 mass % of the entire polycarbonate-based resin composition. The upper limit of the total content of the aromatic polycarbonate-based resin and the UV absorber is not particularly limited, but is, for example, 100 mass % or less from the viewpoint of obtaining a resin composition having desired properties.

### (Flame Retardant)

When the polycarbonate-based resin composition of the present invention includes the above-mentioned aromatic polycarbonate-based resin and the flame retardant, the following effects are exhibited: the polycarbonate-based resin composition and the molded article thereof are each improved in scratch resistance and flame retardancy.

The polycarbonate-based resin composition according to the present invention may include one kind or two or more kinds of flame retardants.

An example of the flame retardant is at least one kind selected from the group consisting of: a phosphorus-based flame retardant; a halogen-based flame retardant; and a metal salt-based flame retardant. From the viewpoint of further improving the flame retardancy, at least one kind selected from the group consisting of: a phosphorus-based flame retardant; and a metal salt-based flame retardant is preferred.

Examples of the phosphorus-based flame retardant include red phosphorus and a phosphoric acid ester-based flame retardant.

The phosphoric acid ester-based flame retardant is preferably free of any halogen, and examples thereof include flame retardants each formed of a monomer, an oligomer, or a polymer of a phosphoric acid ester, or a mixture thereof. Examples thereof include trimethyl phosphate, triethyl phosphate, tributyl phosphate, trioctyl phosphate, tributoxyethyl phosphate, triphenyl phosphate, tricresyl phosphate, cresyldiphenyl phosphate, octyldiphenyl phosphate, tri(2-ethylhexyl) phosphate, diisopropylphenyl phosphate, trixylenyl phosphate, tris(isopropylphenyl) phosphate, trinaphthyl phosphate, bisphenol A bisphosphate, hydroquinone bisphosphate, resorcin bisphosphate, resorcinol-diphenyl phosphate, trioxybenzene triphosphate, and substituted products and condensates thereof. Among them, a condensed phosphoric acid ester is preferred as the phosphoric acid ester-based flame retardant.

Examples of a commercially available phosphoric acid ester compound that may be used as the phosphoric acid ester-based flame retardant include triphenyl phosphate [TPP], trixylenyl phosphate [TXP], resorcinol bis(diphenyl phosphate) [CR733S], bisphenol A bis(diphenyl phosphate) [CR741], 1,3-phenylene-tetrakis(2,6-dimethylphenyl) phosphate [PX200], 1,4-phenylene-tetrakis(2,6-dimethylphenyl) phosphate [PX201L], and 4,4′-biphenylene-tetrakis(2,6-dimethylphenyl) phosphate [PX202] each manufactured by Daihachi Chemical Industry Co., Ltd.

The above-mentioned phosphoric acid ester-based flame retardant is obtained by a reaction among a dihydric phenol, a monohydric phenol represented by Ar⁻OH, and phosphorus oxychloride.

Those phosphoric acid ester-based flame retardants may be used alone or in combination thereof. The phosphoric acid ester-based flame retardant is preferably 1,3-phenylene-tetrakis(2,6-dimethylphenyl) phosphate.

When the polycarbonate-based resin composition according to the present invention includes the phosphorus-based flame retardant as the flame retardant, from the viewpoint of further improving the flame retardancy, the content of the flame retardant is preferably 1.0 part by mass or more, more preferably 2.0 parts by mass or more, still more preferably 3.0 parts by mass or more, still more preferably 5.0 parts by mass or more, still more preferably 7.0 parts by mass or more with respect to 100 parts by mass of the aromatic polycarbonate-based resin. From the viewpoint of further suppressing mold adhesion at the time of the molding of the resin composition or a reduction in heat resistance of the molded article, and the viewpoint of improving the impact resistance and fluidity of the resin composition, the content is preferably 40 parts by mass or less, more preferably 30 parts by mass or less, still more preferably 20 parts by mass or less, still more preferably 15 parts by mass or less, still more preferably 12 parts by mass or less. In addition, when the polycarbonate-based resin composition according to the present invention includes the phosphorus-based flame retardant as the flame retardant, the content of the flame retardant is preferably from 1.0 part by mass to 40 parts by mass, more preferably from 2.0 parts by mass to 30 parts by mass, still more preferably from 3.0 parts by mass to 20 parts by mass, still more preferably from 5.0 parts by mass to 15 parts by mass, still more preferably from 7.0 parts by mass to 12 parts by mass with respect to 100 parts by mass of the aromatic polycarbonate-based resin.

Examples of the halogen-based flame retardant include tetrabromobisphenol A (TBA), a halogenated polycarbonate and a copolymer of a halogenated polycarbonate, an oligomer thereof (TBA carbonate oligomer), decabromodiphenyl ether, a TBA epoxy oligomer, a halogenated polystyrene, and a halogenated polyolefin. The halogen-based flame retardants may be used alone or in combination thereof.

Examples of the metal salt-based flame retardant include an organic alkali metal salt and an organic alkaline earth metal salt. The metal salt-based flame retardant preferably contains at least one kind selected from an organic alkali metal salt and an organic alkaline earth metal salt, and is more preferably at least one kind selected from an organic alkali metal salt and an organic alkaline earth metal salt.

As an organic sulfonic acid salt of the above-mentioned alkali metal or alkaline earth metal (hereinafter sometimes collectively referred to as “alkali (ne earth) metal”), there are given, for example: a metal salt of a fluorine-substituted alkylsulfonic acid such as a metal salt of a perfluoroalkanesulfonic acid and an alkali metal or an alkaline earth metal; and a metal salt of an aromatic sulfonic acid and an alkali metal or an alkaline earth metal.

Examples of the alkali metal include lithium, sodium, potassium, rubidium, and cesium. Examples of the alkaline earth metal include beryllium, magnesium, calcium, strontium, and barium. Among them, the alkali metal is more preferred.

Among those alkali metals, potassium and sodium are preferred, and potassium is more preferred from the viewpoints of flame retardancy and thermal stability.

A potassium salt and a sulfonic acid alkali metal salt formed of another alkali metal may be used in combination.

Examples of the perfluoroalkanesulfonic acid alkali metal salt include potassium perfluorobutanesulfonate, potassium trifluoromethanesulfonate, potassium perfluorohexanesulfonate, potassium perfluorooctanesulfonate, sodium pentafluoroethanesulfonate, sodium perfluorobutanesulfonate, sodium perfluorooctanesulfonate, lithium trifluoromethanesulfonate, lithium perfluorobutanesulfonate, lithium perfluoroheptanesulfonate, cesium trifluoromethanesulfonate, cesium perfluorobutanesulfonate, cesium perfluorooctanesulfonate, cesium perfluorohexanesulfonate, rubidium perfluorobutanesulfonate, and rubidium perfluorohexanesulfonate. Those perfluoroalkanesulfonic acid alkali metal salts may be used alone or in combination thereof.

Here, the number of carbon atoms of the perfluoroalkyl group is preferably from 1 to 18, more preferably from 1 to 10, still more preferably from 1 to 8.

Among them, potassium perfluorobutanesulfonate is preferred.

Examples of the aromatic sulfonic acid alkali(ne earth) metal salt include disodium diphenylsulfide-4,4′-disulfonate, dipotassium diphenylsulfide-4,4′-disulfonate, potassium 5-sulfoisophthalate, sodium 5-sulfoisophthalate, polysodium polyethylene terephthalate polysulfonate, calcium 1-methoxynaphthalene-4-sulfonate, disodium 4-dodecylphenyl ether disulfonate, polysodium poly(2,6-dimethylphenyleneoxide) polysulfonate, polysodium poly(1,3-phenylene oxide) polysulfonate, polysodium poly(1,4-phenylene oxide) polysulfonate, polypotassium poly(2,6-diphenylphenylene oxide) polysulfonate, lithium poly(2-fluoro-6-butylphenylene oxide) polysulfonate, potassium benzenesulfonate, sodium benzenesulfonate, sodium p-toluenesulfonate, strontium benzenesulfonate, magnesium benzenesulfonate, dipotassium p-benzenedisulfonate, dipotassium naphthalene-2,6-disulfonate, calcium biphenyl-3,3′-disulfonate, sodium diphenylsulfone-3-sulfonate, potassium diphenylsulfone-3-sulfonate, dipotassium diphenylsulfone-3,3′-disulfonate, dipotassium diphenylsulfone-3,4′-disulfonate, sodium α,α,α-trifluoroacetophenone-4-sulfonate, dipotassium benzophenone-3,3′-disulfonate, disodium thiophene-2,5-disulfonate, dipotassium thiophene-2,5-disulfonate, calcium thiophene-2,5-disulfonate, sodium benzothiophenesulfonate, potassium diphenylsulfoxide-4-sulfonate, a formalin condensate of sodium naphthalenesulfonate, and a formalin condensate of sodium anthracenesulfonate. Among them, potassium diphenylsulfone-3-sulfonate is preferred.

Among those aromatic sulfonic acid alkali (ne earth) metal salts, a sodium salt and a potassium salt are preferred.

Those metal salt-based flame retardants may be used alone or in combination thereof.

When the polycarbonate-based resin composition according to the present invention includes the metal salt-based flame retardant as the flame retardant, from the viewpoint of further improving the flame retardancy, the content of the flame retardant is preferably 0.01 part by mass or more, more preferably 0.02 part by mass or more, still more preferably 0.03 part by mass or more, still more preferably 0.04 part by mass or more with respect to 100 parts by mass of the aromatic polycarbonate-based resin. From the viewpoint of further suppressing mold adhesion at the time of the molding of the resin composition or a reduction in heat resistance of the molded article, the content is preferably 1.0 part by mass or less, more preferably 0.8 part by mass or less, still more preferably 0.6 part by mass or less, still more preferably 0.4 part by mass or less. In addition, when the polycarbonate-based resin composition according to the present invention includes the metal salt-based flame retardant as the flame retardant, the content of the flame retardant is preferably from 0.01 part by mass to 1.0 part by mass, more preferably from 0.02 part by mass to 0.8 part by mass, still more preferably from 0.03 part by mass to 0.6 part by mass, still more preferably from 0.04 part by mass to 0.4 part by mass with respect to 100 parts by mass of the aromatic polycarbonate-based resin.

From the viewpoint of further improving the balance between the tensile characteristic and flame retardancy, the total content of the aromatic polycarbonate-based resin and the flame retardant in the polycarbonate-based resin composition according to the present invention is preferably 50 mass % or more, more preferably 60 mass % or more, still more preferably 70 mass % or more, still more preferably 80 mass % or more, still more preferably 90 mass % or more, still more preferably 95 mass % or more, still more preferably 98 mass % or more, still more preferably 99 mass % or more with respect to 100 mass % of the entire polycarbonate-based resin composition. The upper limit of the total content of the aromatic polycarbonate-based resin and the flame retardant is not particularly limited, but is, for example, 100 mass % or less from the viewpoint of obtaining a resin composition having desired properties.

### (Polystyrene-Based Resin)

When the polycarbonate-based resin composition of the present invention includes the above-mentioned aromatic polycarbonate-based resin and the polystyrene-based resin, the following effects are exhibited: the fluidity of the polycarbonate-based resin composition is improved; and the molded article thereof is improved in scratch resistance and tensile characteristic.

When the polycarbonate-based resin composition includes the polystyrene-based resin, the polycarbonate-based resin composition preferably includes 1 mass % or more and 30 mass % or less of the polystyrene-based resin with respect to 100 mass % of the total of the aromatic polycarbonate-based resin and the polystyrene-based resin. When the content of the polystyrene-based resin is 1 mass % or more, the tensile characteristic of the molded article to be obtained and the fluidity of the resin can be further improved. When the content of the polystyrene-based resin is 30 mass % or less, the mechanical strength and heat resistance of the molded article can be further improved.

From the viewpoint of further improving the tensile characteristic of the molded article to be obtained and the fluidity of the resin, the content of the polystyrene-based resin in the polycarbonate-based resin composition according to the present invention is preferably 5 mass % or more, more preferably 7 mass % or more, still more preferably 9 mass % or more with respect to 100 mass % of the total of the aromatic polycarbonate-based resin and the polystyrene-based resin. From the viewpoint of further improving the mechanical strength and the heat resistance, the content is preferably 25 mass % or less, more preferably 20 mass % or less, still more preferably 15 mass % or less, still more preferably 12 mass % or less. In addition, the content of the polystyrene-based resin in the polycarbonate-based resin composition according to the present invention is preferably from 5 mass % to 25 mass %, more preferably from 7 mass % to 20 mass %, still more preferably from 9 mass % to 15 mass %, still more preferably from 9 mass % to 12 mass % with respect to 100 mass % of the total of the aromatic polycarbonate-based resin and the polystyrene-based resin.

The polycarbonate-based resin composition according to the present invention may include one kind or two or more kinds of polystyrene-based resins.

From the viewpoint of further improving the tensile characteristic of the molded article to be obtained and the fluidity of the resin, the polystyrene-based resin preferably has a constituent unit derived from acrylonitrile and a constituent unit derived from styrene, and more preferably has a constituent unit derived from butadiene, the constituent unit derived from acrylonitrile, and the constituent unit derived from styrene. An amorphous polystyrene-based resin and a crystalline polystyrene-based resin may be used. In the present invention, the polystyrene-based resins may be used alone or in combination thereof.

The amorphous polystyrene-based resin is, for example, a polymer free of any crystal structure, the polymer being obtained by polymerizing monomers or a monomer mixture formed of: 20 mass % to 100 mass % of a monovinyl-based aromatic monomer, such as styrene or a-methylstyrene; 0 mass % to 60 mass % of a vinyl cyanide-based monomer, such as acrylonitrile or methacrylonitrile; and 0 mass % to 50 mass % of any other vinyl-based monomer copolymerizable therewith, such as maleimide or methyl (meth)acrylate.

Examples of such polymer include general-purpose polystyrene (GPPS) and an acrylonitrile-styrene copolymer (AS resin).

In addition, a rubber-modified polystyrene-based resin reinforced with a rubber-like polymer may be preferably utilized as the amorphous polystyrene-based resin. The rubber-modified polystyrene-based resin is preferably an acrylonitrile-butadiene-styrene copolymer, and examples thereof include: a high impact polystyrene (HIPS) obtained by polymerizing a rubber such as a polybutadiene with styrene; an acrylonitrile-butadiene-styrene copolymer (ABS resin) obtained by polymerizing a polybutadiene with acrylonitrile and styrene; and a methyl methacrylate-butadiene-styrene copolymer (MBS resin) obtained by polymerizing a polybutadiene with methyl methacrylate and styrene. The rubber-modified polystyrene-based resins may be used in combination thereof, and may each also be used as a mixture with the amorphous polystyrene-based resin that is not modified with any rubber.

The content of the rubber in the rubber-modified polystyrene-based resin is preferably from 2 mass % to 50 mass %, more preferably from 5 mass % to 30 mass %, still more preferably from 5 mass % to 15 mass %. When the ratio of the rubber is 2 mass % or more, the impact resistance of the resin can be improved, and when the ratio is 50 mass % or less, a reduction in thermal stability thereof, a reduction in melt fluidity thereof, gel generation, the coloring thereof, and the like can be suppressed.

Specific examples of the above-mentioned rubber include a polybutadiene, a rubbery polymer containing an acrylate and/or a methacrylate, a styrene-butadiene-styrene rubber (SBS), a styrene-butadiene rubber (SBR), a butadiene-acrylic rubber, an isoprene rubber, an isoprene-styrene rubber, an isoprene-acrylic rubber, and an ethylene-propylene rubber. Among them, a polybutadiene is preferred. Any one of a polybutadiene having a low 1,4-cis bond content (e.g., a polybutadiene containing 1 mol % to 30 mol % of a 1,2-vinyl bond and 30 mol % to 42 mol % of a 1,4-cis bond) and a polybutadiene having a high 1,4-cis bond content (e.g., a polybutadiene containing 20 mol % or less of a 1,2-vinyl bond and 78 mol % or more of a 1,4-cis bond) may be used as the polybutadiene to be used here, or a mixture thereof may be used.

In addition, examples of the crystalline polystyrene-based resin include styrene-based (co) polymers each having a syndiotactic structure or an isotactic structure. In the present invention, the amorphous polystyrene-based resin is preferably used for the purpose of further improving the fluidity of the resin composition. Further, among the amorphous polystyrene-based resins, a resin having a melt flow rate (MFR) at 200° C. and a load of 5 kg of preferably from 0.5 g/10 min to 100 g/10 min, more preferably from 2 g/10 min to 80 g/10 min, still more preferably from 2 g/10 min to 50 g/10 min is used. When the melt flow rate (MFR) is 5 g/10 min or more, sufficient fluidity is obtained, and when the MFR is 100 g/10 min or less, the impact resistance of the polycarbonate-based resin composition becomes satisfactory.

From the viewpoint of further improving the tensile characteristic of the molded article to be obtained and the fluidity of the resin, the polystyrene-based resin is preferably at least one kind selected from the group consisting of: a high impact polystyrene resin (HIPS); an acrylonitrile-styrene copolymer (AS resin); an acrylonitrile-butadiene-styrene copolymer (ABS resin); a methyl methacrylate-styrene copolymer (MS resin); a methyl methacrylate-butadiene-styrene copolymer (MBS resin); an acrylonitrile-methyl acrylate-styrene copolymer (AAS resin); and an acrylonitrile-(ethylene/propylene/diene copolymer)-styrene copolymer (AES resin), more preferably at least one kind selected from the group consisting of: an acrylonitrile-styrene copolymer (AS resin); an acrylonitrile-butadiene-styrene copolymer (ABS resin); and a methyl methacrylate-butadiene-styrene copolymer (MBS resin), still more preferably at least one kind selected from the group consisting of: an acrylonitrile-butadiene-styrene copolymer (ABS resin); and an acrylonitrile-styrene copolymer (AS resin) among the amorphous polystyrene-based resins.

From the viewpoint of further improving the tensile characteristic of the molded article to be obtained and the fluidity of the resin, the total content of the aromatic polycarbonate-based resin and the polystyrene-based resin in the polycarbonate-based resin composition according to the present invention is preferably 50 mass % or more, more preferably 60 mass % or more, still more preferably 70 mass % or more, still more preferably 80 mass % or more, still more preferably 90 mass % or more, still more preferably 95 mass % or more, still more preferably 98 mass % or more, still more preferably 99 mass % or more with respect to 100 mass % of the entire polycarbonate-based resin composition. The upper limit of the total content of the aromatic polycarbonate-based resin and the polystyrene-based resin is not particularly limited, but is, for example, 100 mass % or less from the viewpoint of obtaining a resin composition having desired properties.

### (Polyester-Based Resin)

When the polycarbonate-based resin composition of the present invention includes the above-mentioned aromatic polycarbonate-based resin and the polyester-based resin, the following effects are exhibited: the polycarbonate-based resin composition and the molded article thereof are each improved in scratch resistance and chemical resistance.

When the polycarbonate-based resin composition includes the polyester-based resin, the composition preferably includes 1 mass % to 50 mass % of the polyester-based resin with respect to 100 mass % of the total of the aromatic polycarbonate-based resin and the polyester-based resin. When the content of the polyester-based resin is 1 mass % or more, the balance between the tensile characteristic and chemical resistance of the molded article to be obtained can be further improved. When the content of the polyester-based resin is 50 mass % or less, the balance between the tensile characteristic and the chemical resistance can be further improved.

From the viewpoint of further improving the balance between the tensile characteristic and the chemical resistance, the content of the polyester-based resin in the polycarbonate-based resin composition according to the present invention is preferably 5 mass % or more, more preferably 10 mass % or more, still more preferably 15 mass % or more, still more preferably 18 mass % or more with respect to 100 mass % of the total of the aromatic polycarbonate-based resin and the polyester-based resin. From the viewpoint of further improving the balance between the tensile characteristic and the chemical resistance, the content is preferably 40 mass % or less, more preferably 35 mass % or less, still more preferably 30 mass % or less, still more preferably 25 mass % or less. In addition, the content of the polyester-based resin in the polycarbonate-based resin composition according to the present invention is preferably from 5 mass % to 40 mass %, more preferably from 10 mass % to 35 mass %, still more preferably from 15 mass % to 30 mass %, still more preferably from 18 mass % to 25 mass % with respect to 100 mass % of the total of the aromatic polycarbonate-based resin and the polyester-based resin.

The polycarbonate-based resin composition according to the present invention may include one kind or two or more kinds of polyester-based resins.

The polyester-based resin is a polymer or copolymer of a polyvalent carboxylic acid and a polyhydric alcohol. The polyester-based resin is preferably a polymer or copolymer of an aromatic dicarboxylic acid and a diol, or is preferably a polymer or copolymer obtained by a condensation reaction involving using an aromatic dicarboxylic acid or a reactive derivative thereof and a diol or an ester derivative thereof as main components.

Examples of the aromatic dicarboxylic acid include terephthalic acid, isophthalic acid, orthophthalic acid, 1,5-naphthalenedicarboxylic acid, 2,6-naphthalenedicarboxylic acid, 4,4′-biphenyldicarboxylic acid, 4,4′-biphenyletherdicarboxylic acid, 4,4′-biphenylmethanedicarboxylic acid, 4,4′-biphenylsulfonedicarboxylic acid, 4,4′-biphenylisopropylidenedicarboxylic acid, 1,2-bis(phenoxy) ethane-4,4′-dicarboxylic acid, 2,5-anthracenedicarboxylic acid, 2,6-anthracenedicarboxylic acid, 4,4′-p-terphenylenedicarboxylic acid, and 2,5-pyridinedicarboxylic acid. Substituted products thereof (e.g., alkyl group-substituted products such as 5-methylisophthalic acid), reactive derivatives thereof (e.g., alkyl ester derivatives, such as dimethyl terephthalate and diethyl terephthalate), and the like may also be used.

Among them, terephthalic acid, 2,6-naphthalenedicarboxylic acid, and alkyl ester derivatives thereof are more preferred, and terephthalic acid and alkyl ester derivatives thereof are still more preferred. Those aromatic dicarboxylic acids may be used alone or in combination thereof. One or more kinds of, for example, aliphatic dicarboxylic acids, such as adipic acid, azelaic acid, sebacic acid, and dodecanedioic acid, and alicyclic dicarboxylic acids such as cyclohexanedicarboxylic acid may be used in combination with the aromatic dicarboxylic acid.

Examples of the diol that is the component of the polyester-based resin may include: aliphatic diols, such as ethylene glycol, diethylene glycol, 1,2-propylene glycol, 1,3-propanediol, triethylene glycol, 1,4-butanediol, neopentyl glycol, 1,5-pentanediol, 1,6-hexanediol, decamethylene glycol, and 2,2-dimethyl-1,3-propanediol; alicyclic diols, such as 1,4-cyclohexanedimethanol, 1,3-cyclohexanedimethanol, cyclohexanediol, and trans- or cis-2,2,4,4-tetramethyl-1,3-cyclobutanediol; and aromatic diols, such as p-xylenediol, bisphenol A, tetrabromobisphenol A, and tetrabromobisphenol A-bis(2-hydroxyethyl ether). Substituted products thereof may also be used.

Among them, in terms of heat resistance, dimensional stability, and the like, an aliphatic diol is preferred, ethylene glycol, 1,4-butanediol, or 1,4-cyclohexanedimethanol is more preferred, and ethylene glycol is still more preferred. The diols may be used alone or in combination thereof. In addition, one or more kinds of long-chain diols each having a molecular weight of from 400 to 6,000, that is, for example, a polyethylene glycol, a poly-1,3-propylene glycol, and a polytetramethylene glycol may be used as diol components in combination with the above-mentioned diols and copolymerized therewith.

The polyester-based resin may be copolymerized with a hydroxycarboxylic acid such as parahydroxybenzoic acid, any other carboxylic acid, or an alcohol except the above-mentioned diols, and such copolymerized resin may also be used in this embodiment. However, the amount of such copolymerized component is preferably small, and components derived from the aromatic dicarboxylic acid and the aliphatic diol account for preferably 80 mass % or more, more preferably 90 mass % or more of the polyester-based resin. In addition, one kind of compound accounts for preferably 80 mol % or more, more preferably 90 mol % or more of each of the aromatic dicarboxylic acid and the aliphatic diol.

The polyester-based resin may be branched by introducing a small amount of a branching agent. The kind of the branching agent is not limited, but examples thereof include trimesic acid, trimellitic acid, trimethylolethane, trimethylolpropane, and pentaerythritol.

Examples of the polyester-based resin include polyethylene terephthalate (PET), polypropylene terephthalate, polybutylene terephthalate (PBT), polyhexylene terephthalate, polyethylene naphthalate (PEN), polybutylene naphthalate (PBN), polyethylene-1,2-bis(phenoxy) ethane-4,4′-dicarboxylate, and copolymerized polyester resins, such as polyethylene isophthalate/terephthalate and polybutylene terephthalate/isophthalate. Among them, polyethylene terephthalate, polybutylene terephthalate, polyethylene naphthalate, polybutylene naphthalate, and a mixtures thereof, in which mechanical properties and the like are balanced, may be preferably used.

From the viewpoint of further improving the balance between the tensile characteristic and the chemical resistance, the polyester-based resin preferably contains at least one kind selected from the group consisting of: polyethylene terephthalate; polybutylene terephthalate; polyethylene naphthalate; and polybutylene naphthalate, more preferably contains at least one kind selected from the group consisting of: polyethylene terephthalate; and polybutylene terephthalate, and is still more preferably at least one kind selected from the group consisting of: polyethylene terephthalate; and polybutylene terephthalate.

In addition, from the viewpoint of further improving the tensile characteristic, the polyester-based resin preferably contains polyethylene terephthalate, and is more preferably polyethylene terephthalate.

The compounds preferably have a ratio “PET:PBT” of, for example, from 1:1 to 1:8 (mass ratio) when used in combination.

From the viewpoint of further improving the balance between the tensile characteristic and the chemical resistance, the total content of the aromatic polycarbonate-based resin and the polyester-based resin in the polycarbonate-based resin composition according to the present invention is preferably 50 mass % or more, more preferably 60 mass % or more, still more preferably 70 mass % or more, still more preferably 80 mass % or more, still more preferably 90 mass % or more, still more preferably 95 mass % or more, still more preferably 98 mass % or more, still more preferably 99 mass % or more with respect to 100 mass % of the entire polycarbonate-based resin composition. The upper limit of the total content of the aromatic polycarbonate-based resin and the polyester-based resin is not particularly limited, but is, for example, 100 mass % or less from the viewpoint of obtaining a resin composition having desired properties.

### (Inorganic Filler)

When the polycarbonate-based resin composition of the present invention includes the above-mentioned aromatic polycarbonate-based resin and the inorganic filler, the following effects are exhibited: the polycarbonate-based resin composition and the molded article thereof are each improved in scratch resistance and rigidity.

When the polycarbonate-based resin composition includes the inorganic filler, the polycarbonate-based resin composition preferably includes 0.1 part by mass to 100 parts by mass of the inorganic filler with respect to 100 parts by mass of the aromatic polycarbonate-based resin. When the content of the inorganic filler is 0.1 part by mass or more, the balance between the tensile characteristic and the rigidity can be further improved. When the content of the inorganic filler is 100 parts by mass or less, for example, the moldability and the impact resistance can be further improved.

From the viewpoint of further improving the balance between the tensile characteristic and the rigidity, the content of the inorganic filler in the polycarbonate-based resin composition according to the present invention is more preferably 0.5 part by mass or more, still more preferably 1.0 part by mass or more, still more preferably 2.0 parts by mass or more, still more preferably 3.0 parts by mass or more, still more preferably 4.0 parts by mass or more with respect to 100 parts by mass of the aromatic polycarbonate-based resin. From the viewpoint of further improving the moldability and the impact resistance, the content is more preferably 50 parts by mass or less, still more preferably 20 parts by mass or less, still more preferably 15 parts by mass or less, still more preferably 12 parts by mass or less. In addition, the content of the inorganic filler in the polycarbonate-based resin composition according to the present invention is more preferably from 0.5 part by mass to 50 parts by mass, still more preferably from 1.0 part by mass to 20 parts by mass, still more preferably from 2.0 parts by mass to 15 parts by mass, still more preferably from 3.0 parts by mass to 12 parts by mass, still more preferably from 4.0 parts by mass to 12 parts by mass with respect to 100 parts by mass of the aromatic polycarbonate-based resin.

The polycarbonate-based resin composition according to the present invention may include one kind or two or more kinds of inorganic fillers.

The inorganic filler is, for example, at least one kind selected from the group consisting of: a glass filler (e.g., glass fibers, glass beads, glass flakes, or glass powder); carbon fibers; aluminum fibers; calcium carbonate; magnesium carbonate; dolomite; silica; diatomaceous earth; alumina; titanium oxide; iron oxide; zinc oxide; magnesium oxide; calcium sulfate; magnesium sulfate; calcium sulfite; talc; clay; mica; asbestos; calcium silicate; montmorillonite; bentonite; carbon black; graphite; iron powder; lead powder; aluminum powder; and a white pigment. Among them, a glass filler is preferred, and glass fibers are more preferred from the viewpoint of further improving the balance between the tensile characteristic and the rigidity.

The white pigment is not particularly limited, but is preferably at least one kind selected from the group consisting of: titanium oxide; zinc oxide; and zinc sulfide. Among those white pigments, titanium oxide is preferred from the viewpoint of making the color tone of the resin composition whiter.

Titanium oxide whose surface is coated with a polyol is preferred as titanium oxide. Such coating can improve the dispersibility of titanium oxide in the polycarbonate-based resin composition and prevent a reduction in molecular weight of the polycarbonate.

The surface treatment of titanium oxide with an organic compound may be, for example, surface coating with an organosilicon compound, an alkanolamine, or a higher fatty acid in addition to the polyol. Further, for example, before the coating of the surface of titanium oxide with the polyol, the surface may be coated with a hydrous oxide and/or an oxide of at least one kind of element including an element, such as aluminum, silicon, magnesium, zirconia titanium, or tin.

Examples of the polyol to be used when titanium oxide is coated with the polyol include trimethylolpropane, trimethylolethane, ditrimethylolpropane, trimethylolpropane ethoxylate, and pentaerythritol. Among them, trimethylolpropane and trimethylolethane are preferred.

A method of coating the surface with the polyol is, for example, a wet method or a dry method. The wet method is performed by a method including: adding titanium oxide to the mixed liquid of the polyol and a low-boiling point solvent; stirring the mixture; and then removing the low-boiling point solvent. The dry method is performed by a method including mixing the polyol and titanium oxide in a mixer, such as a Henschel mixer or a tumbler, or spraying titanium oxide with a mixed solution obtained by dissolving or dispersing the polyol in a solvent. Such coating of the surface with the polyol can suppress reductions in physical properties of the polycarbonate-based resin composition, improve the dispersibility of titanium oxide in the resin composition, and suppress a molding failure such as a silver streak.

Titanium oxide produced by using any one of a chlorine method and a sulfuric acid method as a method of producing titanium oxide may be used. In addition, although any one of a rutile type and an anatase type may be used as the crystal structure of titanium oxide, the rutile type is more preferred from the viewpoints of, for example, the thermal stability and light fastness of the polycarbonate-based resin composition.

A product commercially available as an additive for a thermoplastic resin may be arbitrarily used as talc. Talc is a hydrous silicate of magnesium, and contains a trace amount of aluminum oxide, calcium oxide, or iron oxide in addition to silicic acid and magnesium oxide serving as main components in some cases. Talc may contain such material. In addition, the average particle diameter of talc falls within the range of preferably 0.5 μm or more, more preferably 1 μm or more, and falls within the range of preferably 50 μm or less, more preferably 20 μm or less. In addition, the average particle diameter falls within the range of preferably from 0.5 μm to 50 μm, more preferably from 1 μm to 20 μm. The aspect ratio thereof falls within the range of, for example, from 2 or more to 20 or less. The average particle diameter and the aspect ratio are determined in comprehensive consideration of, for example, any other component to be incorporated for achieving the fluidity of the resin composition at the time of its molding, and impact resistance, rigidity, and the like that the molded article is required to have. In addition, for example, talc subjected to surface treatment with a fatty acid or the like, or talc pulverized in the presence of a fatty acid or the like may be used as talc.

When the glass fibers are blended as the inorganic filler into the polycarbonate-based resin composition according to the present invention, the rigidity of the molded article can be further improved. Fibers produced by using alkali-containing glass, low-alkali glass, or alkali-free glass as a material are preferred as the glass fibers, and the form of each of the fibers may be any one of, for example, the following forms: a roving, a milled fiber, and a chopped strand. In addition, the cross-sections of the glass fibers may each be a flat shape. The diameter of each of the glass fibers is preferably from 3 μm to 30 μm, and fibers each having a length of from 1 mm to 6 mm are preferably used. When the diameter of each of the glass fibers is 3 μm or more, the rigidity of the polycarbonate-based resin composition can be further improved, and when the diameter is 30 μm or less, the appearance of the molded article becomes satisfactory.

The fiber length of each of the glass fibers is, for example, from 0.01 mm to 8 mm, preferably from 0.1 mm to 6 mm. In addition, the fiber diameter thereof is, for example, from about 0.1 μm to about 30 μm, preferably from 0.5 μm to 25 μm. Those glass fibers may be used alone or as a mixture thereof.

Glass fibers subjected to surface treatment with, for example, a silane-based coupling agent, such as an aminosilane-, epoxysilane-, vinylsilane-, or methacrylsilane-based coupling agent, a chromium complex compound, or a boron compound may be used for improving an affinity for the resin, and fibers subjected to sizing treatment with a sizing agent may also be used. For example, MA-409C (average fiber diameter: 13 μm) or TA-409C (average fiber diameter: 23 μm) manufactured by Asahi Fiber Glass Co., Ltd., or T-511 (average fiber diameter: from 12 μm to 14 μm) manufactured by Nippon Electric Glass Co., Ltd. may be suitably used as such glass fibers.

When the polycarbonate-based resin composition according to the present invention includes titanium oxide as the inorganic filler, from the viewpoint of further improving the balance between the tensile characteristic and the rigidity, and the viewpoint of improving the whiteness of the resin composition, the content of the inorganic filler is preferably 0.5 part by mass or more, more preferably 1.0 part by mass or more, still more preferably 2.0 parts by mass or more with respect to 100 parts by mass of the aromatic polycarbonate-based resin. From the viewpoint of further improving the moldability and the impact resistance, the content is preferably 50 parts by mass or less, more preferably 40 parts by mass or less. In addition, when the polycarbonate-based resin composition according to the present invention includes titanium oxide as the inorganic filler, the content of the inorganic filler is preferably from 0.5 part by mass to 50 parts by mass, more preferably from 1.0 part by mass to 40 parts by mass, still more preferably from 2.0 parts by mass to 40 parts by mass with respect to 100 parts by mass of the aromatic polycarbonate-based resin.

When the polycarbonate-based resin composition according to the present invention includes talc as the inorganic filler, from the viewpoint of further improving the balance between the tensile characteristic and the rigidity, and the viewpoint of improving the dimensional stability, the content of the inorganic filler is preferably 0.5 part by mass or more, more preferably 1.0 part by mass or more, still more preferably 2.0 parts by mass or more, still more preferably 3.0 parts by mass or more, still more preferably 4.0 parts by mass or more with respect to 100 parts by mass of the aromatic polycarbonate-based resin. From the viewpoint of further improving the moldability and the impact resistance, the content is preferably 100 parts by mass or less, more preferably 50 parts by mass or less, still more preferably 20 parts by mass or less, still more preferably 15 parts by mass or less, still more preferably 12 parts by mass or less, still more preferably 10 parts by mass or less, still more preferably 8.0 parts by mass or less. When the polycarbonate-based resin composition according to the present invention includes talc as the inorganic filler, the content of the inorganic filler is preferably from 0.5 part by mass to 100 parts by mass, more preferably from 1.0 part by mass to 50 parts by mass, still more preferably from 2.0 parts by mass to 20 parts by mass, still more preferably from 3.0 parts by mass to 15 parts by mass, still more preferably from 3.0 parts by mass to 12 parts by mass, still more preferably from 4.0 parts by mass to 10 parts by mass, still more preferably from 4.0 parts by mass to 8.0 parts by mass with respect to 100 parts by mass of the aromatic polycarbonate-based resin.

When the polycarbonate-based resin composition according to the present invention includes the glass fibers as the inorganic filler, from the viewpoint of further improving the balance between the tensile characteristic and the rigidity, and the viewpoint of improving the dimensional stability, the content of the inorganic filler is preferably 0.5 part by mass or more, more preferably 1.0 part by mass or more, still more preferably 2.0 parts by mass or more, still more preferably 3.0 parts by mass or more, still more preferably 4.0 parts by mass or more, still more preferably 6.0 parts by mass or more, still more preferably 8.0 parts by mass or more with respect to 100 parts by mass of the aromatic polycarbonate-based resin. From the viewpoint of further improving the moldability and the impact resistance, and the viewpoint of further improving the appearance, the content is preferably 100 parts by mass or less, more preferably 50 parts by mass or less, still more preferably 20 parts by mass or less, still more preferably 15 parts by mass or less, still more preferably 12 parts by mass or less. In addition, when the polycarbonate-based resin composition according to the present invention includes the glass fibers as the inorganic filler, the content of the inorganic filler is preferably from 0.5 part by mass to 100 parts by mass, more preferably from 1.0 part by mass to 50 parts by mass, still more preferably from 2.0 parts by mass to 20 parts by mass, still more preferably from 3.0 parts by mass to 15 parts by mass, still more preferably from 4.0 parts by mass to 15 parts by mass, still more preferably from 6.0 parts by mass to 12 parts by mass, still more preferably from 8.0 parts by mass to 12.0 parts by mass with respect to 100 parts by mass of the aromatic polycarbonate-based resin.

From the viewpoint of further improving the balance between the tensile characteristic and the rigidity, the total content of the aromatic polycarbonate-based resin and the inorganic filler in the polycarbonate-based resin composition according to the present invention is preferably 50 mass % or more, more preferably 60 mass % or more, still more preferably 70 mass % or more, still more preferably 80 mass % or more, still more preferably 90 mass % or more, still more preferably 95 mass % or more, still more preferably 98 mass % or more, still more preferably 99 mass % or more with respect to 100 mass % of the entire polycarbonate-based resin composition. The upper limit of the total content of the aromatic polycarbonate-based resin and the inorganic filler is not particularly limited, but is, for example, 100 mass % or less from the viewpoint of obtaining a resin composition having desired properties.

When the polycarbonate-based resin composition of the present invention includes at least two or more kinds selected from the group consisting of: a UV absorber; a flame retardant; a polystyrene-based resin; a polyester-based resin; and an inorganic filler, the polycarbonate-based resin composition can exhibit respective effects derived from the respective components.

The content of the aromatic polycarbonate-based resin in the polycarbonate-based resin composition of the present invention varies depending on which of the UV absorber, the flame retardant, the polystyrene-based resin, the polyester-based resin, and the inorganic filler is included in the polycarbonate-based resin composition, but the content is preferably 60 mass % or more, more preferably 65 mass % or more, still more preferably 70 mass % or more, and is preferably 99.99 mass % or less, more preferably 99.97 mass % or less, still more preferably 99.96 mass % or less. In addition, the content of the aromatic polycarbonate-based resin in the polycarbonate-based resin composition of the present invention is preferably from 60 mass % to 99.99 mass %, more preferably from 65 mass % to 99.97 mass %, still more preferably from 70 mass % to 99.96 mass %.

The polycarbonate-based resin composition of the present invention may include an additive, such as a hydrolysis resistant agent, an antioxidant, a flame retardant aid, a pigment, or a dye, in addition to the aromatic polycarbonate-based resin, the UV absorber, the flame retardant, the polystyrene-based resin, the polyester-based resin, and the inorganic filler.

The polycarbonate-based resin composition may include an antioxidant from, for example, the viewpoint that its oxidative deterioration at the time of melting can be prevented, and hence its coloring or the like due to the oxidative deterioration is prevented.

The content of the antioxidant is preferably from 0.001 part by mass to 0.5 part by mass, more preferably from 0.01 part by mass to 0.3 part by mass, still more preferably from 0.02 part by mass to 0.2 part by mass with respect to 100 parts by mass of the content of the aromatic polycarbonate-based resin. When the content of the antioxidant falls within the above-mentioned ranges, a sufficient antioxidant action is obtained, and mold contamination at the time of the molding can be suppressed.

A method of producing the polycarbonate-based resin composition of the present invention is not particularly limited as long as the method includes a step of mixing the above-mentioned aromatic polycarbonate-based resin, and at least one kind selected from the group consisting of: a UV absorber; a flame retardant; a polystyrene-based resin; a polyester-based resin; and an inorganic filler. The composition may be produced by, for example, mixing the above-mentioned aromatic polycarbonate-based resin, and at least one kind selected from the group consisting of: a UV absorber; a flame retardant; a polystyrene-based resin; a polyester-based resin; and an inorganic filler with a mixer or the like, and melting and kneading the mixture. The melting and kneading may be performed by a typically used method such as a method including using, for example, a ribbon blender, a Henschel mixer, a Banbury mixer, a drum tumbler, a single-screw extruder, a twin-screw extruder, a co-kneader, or a multi-screw extruder. A heating temperature at the time of the melting and kneading is appropriately selected from the range of, for example, from 150° C. to 300° C., preferably from about 220° C. to about 300° C.

### 2. Molded Article

The molded article of the present invention includes the above-mentioned polycarbonate-based resin composition. The molded article may be produced through use of a melt-kneaded product of the polycarbonate-based resin composition or a pellet thereof obtained through melting and kneading as a raw material by an injection molding method, an injection compression molding method, an extrusion molding method, a blow molding method, a press molding method, a vacuum molding method, an expansion molding method, or the like. In particular, the molded article is preferably produced through use of a pellet obtained through melting and kneading by an injection molding method or an injection compression molding method.

The thickness of the molded article may be arbitrarily set in accordance with applications, and particularly when the transparency of the molded article is required, the thickness is preferably from 0.2 mm to 4.0 mm, more preferably from 0.3 mm to 3.0 mm, still more preferably from 0.3 mm to 2.0 mm. When the thickness of the molded article is 0.2 mm or more, no warping occurs, and hence satisfactory mechanical strength is obtained. In addition, when the thickness of the molded article is 4.0 mm or less, high transparency is obtained.

The polycarbonate-based resin composition of the present invention can improve the scratch resistance of a molded article thereof, and hence may be suitably used in a scratch-resistant application.

The scratch-resistant application is, for example, a structural body whose outer surface is formed of the above-mentioned polycarbonate-based resin composition, and more specific examples thereof include a resin window, a touch panel, an interior supply, an exterior supply, an interior part or an exterior part of a vehicle, a casing, an electric appliance part, a building material, and an OA equipment part. The polycarbonate-based resin composition of the present invention may be suitably used for producing the above-mentioned articles.

The molded article formed of the polycarbonate-based resin composition of the present invention may be suitably used as, for example, a resin window, a touch panel, an interior supply, an exterior supply, an interior part or an exterior part of a vehicle, a casing, an electric appliance part, or a building material.

### EXAMPLES

Examples of the present invention are further described. The present invention is by no means limited by these examples. Measurement and evaluations in the respective examples were performed by the following methods.

### 1. Measurement of Viscosity-Average Molecular Weight (Mv)

A viscosity-average molecular weight (Mv) was calculated from the following equation (Schnell's equation) after the determination of a limiting viscosity [n] through the measurement of the viscosity of a methylene chloride solution (concentration: g/L) at 20° C. with an Ubbelohde-type viscometer.

$$[ η ] = 1.23 \times {10}^{- 5} {Mv}^{0.83}$$

### 2. Conditions for ¹H-NMR Measurement

Nuclear magnetic resonance (NMR) apparatus:
“ECA-500” manufactured by JEOL
RESONANCE Co., Ltd.
Probe: 50TH5AT/FG2
Measurement nucleus: ¹H
Observation width: from −5 ppm to 15 ppm
Observation center: 5 ppm
Pulse repetition time: 9 seconds
Pulse width: 45°
NMR sample tube: 5 mmφ
Sample amount: from 30 mg to 40 mg
Solvent: deuterochloroform
Solvent amount: 0.4 mL
Measurement temperature: 25° C.
Number of scans: 256 times
Chemical shift correction: the peak of a methyl group derived from bisphenol
A in a sample is set to a reference of 1.68 ppm.

### 3. Determination of Composition Ratio of Aromatic Polycarbonate-Based Resin

The ¹H-NMR measurement of a sample dissolved in deuterochloroform was performed with “ECA-500” manufactured by JEOL RESONANCE Co., Ltd. under the same measurement conditions as those described above, and the structure of an aromatic polycarbonate-based resin was assigned.

### Synthesis Example 1 (Synthesis of Cyclohexyl Diphenolate)

620 Milliliters of cyclohexanol, 111 g (388 mmol) of diphenolic acid, and 5.69 g (58.0 mmol) of sulfuric acid were loaded into a 1-liter flask to provide a reaction liquid, and a stirrer chip, a temperature gauge, and a reflux tube were set therein. The temperature of the reaction liquid was increased to 80° C. with an oil bath, and the liquid was stirred with a magnetic stirrer for 19 hours. The disappearance of diphenolic acid was recognized by thin-layer chromatography (TLC), and then the temperature of the reaction liquid was returned to room temperature. 600 Milliliters of toluene was loaded into the reaction liquid, and the mixture was washed with 800 mL of baking soda water (saturated aqueous solution of sodium hydrogen carbonate) twice and with 800 mL of brine (saturated salt solution) once. The organic phase was dried with anhydrous sodium sulfate, and was then concentrated under reduced pressure to provide 316 g of a pale brown liquid as a crude product. The resultant crude product was purified with a silica gel column (neutral silica gel: 1.05 kg, solvent: heptane/ethyl acetate=4/1) to provide 263 g of a pale yellow liquid. The resultant pale yellow liquid was subjected to azeotropy with a mixed solvent containing acetonitrile and water at 2:1 (300 g) eight times. The precipitated solid was recovered by filtration under reduced pressure, and was subjected to suspension washing with 500 mL of hexane twice. The resultant solid was dried under reduced pressure at 40° C. for 12 hours to provide 113 g of a white solid of cyclohexyl diphenolate.

### Synthesis Example 2 (Synthesis of Cyclopentyl Diphenolate)

694 Milliliters of cyclopentanol, 124 g (434 mmol) of diphenolic acid, and 6.37 g (65.0 mmol) of sulfuric acid were loaded into a 1-liter flask to provide a reaction liquid, and a stirrer chip, a temperature gauge, and a reflux tube were set therein. The temperature of the reaction liquid was increased to 80° C. with an oil bath, and the liquid was stirred with a magnetic stirrer for 19 hours. The disappearance of diphenolic acid was recognized by thin-layer chromatography (TLC), and then the temperature of the reaction liquid was returned to room temperature. 600 Milliliters of toluene was loaded into the reaction liquid, and the mixture was washed with 600 mL of baking soda water (saturated aqueous solution of sodium hydrogen carbonate) twice and with 600 mL of brine (saturated salt solution) once. The organic phase was dried with anhydrous sodium sulfate, and was then concentrated under reduced pressure to provide 172 g of a pale brown liquid as a crude product. The resultant crude product was dissolved in a mixture (350 g) containing hexane and ethyl acetate at 9:1, and the solution was left at room temperature overnight. The precipitated solid was recovered by filtration under reduced pressure, and was dried under reduced pressure at 40° C. for 12 hours to provide a white solid (55.3 g) of cyclopentyl diphenolate. The filtrate was left at rest at 4° C. overnight, and the precipitated solid was recovered by filtration under reduced pressure. The recovered solid was dried under reduced pressure at 40° C. for 12 hours to provide a white solid (38.5 g) of cyclopentyl diphenolate. The filtrate was concentrated under reduced pressure, and the resultant liquid was dissolved in chloroform (100 g). Toluene (180 g) was added to the solution, and the mixture was left at 4° C. overnight. The precipitated solid was recovered by filtration under reduced pressure, and was subjected to suspension washing with hexane twice. The washed solid was dried under reduced pressure at 50° C. for 12 hours to provide a white solid (14.4 g) of cyclopentyl diphenolate. A total of 108.2 g of cyclopentyl diphenolate was obtained.

### Synthesis Example 3 (Synthesis of Cyclohexyl 2,2-Bis(4-hydroxyphenyl)propanoate)

Phenol (131 g, 1.39 mol), pyruvic acid (60.3 g, 0.68 mol), and ion-exchanged water (45.6 g) were loaded into a 1-liter four-necked flask, and a stirrer chip and a temperature gauge were set therein. The flask was cooled with ice, and 95% sulfuric acid (112 g, 1.14 mol) was dropped thereinto over 50 minutes. After that, the temperature of the reaction liquid was increased to room temperature, and the liquid was stirred for 14 hours. Diethyl ether (1 L) was loaded into the reaction liquid, and the mixture was washed with ion-exchanged water (1 L) once. The organic layer was extracted with 0.1 M aqueous sodium hydroxide (1 L) twice. The pH of the extract was adjusted to 2 with 1 M hydrochloric acid, and the extract was extracted with diethyl ether (1 L) twice. The extract was dried with sodium sulfate, and was then dried under reduced pressure to provide a pale brown solid (139 g). The pale brown solid (130 g), cyclohexanol (2.01 L), and 95% sulfuric acid (27.7 g, 0.28 mol) were loaded into a 5-liter four-necked flask, and a stirring blade, a temperature gauge, and a reflux tube were set therein. After that, the temperature of the reaction liquid was increased to 100° C., and the liquid was stirred for 15 days. The reaction liquid was diluted twofold with diethyl ether, and was washed with baking soda water twice, with water once, and with brine once. The organic layer was dried with magnesium sulfate, and was concentrated under reduced pressure to provide a crude product (815 g). The crude product was purified with a silica gel column (neutral silica gel: 5.0 kg, solvent: chloroform/ethyl acetate=1/0→0/1) three times. After that, the purified product was dissolved in a solution containing chloroform and ethyl acetate at 1:1, and the solution was subjected to a recrystallization operation to provide a white solid (52.9 g) of cyclohexyl 2,2-bis(4-hydroxyphenyl)propanoate.

### Synthesis Example 4 (Synthesis of Methyl Diphenolate)

500 Milliliters of methanol, 50 g (175 mmol) of diphenolic acid, and 2.5 mL of sulfuric acid were loaded into a 1-liter flask, and a stirrer chip, a temperature gauge, and a reflux tube were set therein. The temperature of the reaction liquid was increased to 70° C. with an oil bath, and the liquid was stirred with a magnetic stirrer for 5 hours. The temperature of the reaction liquid was returned to room temperature, and then the liquid was concentrated under reduced pressure. Ethyl acetate was loaded into the reaction liquid, and the mixture was washed with 100 mL of baking soda water three times and with 100 ml of water twice. The solution was concentrated under reduced pressure to provide 55.3 g of a colorless solid as a crude product. The resultant crude product and 100 mL of toluene were loaded into a 200-milliliter flask, and a stirrer chip, a temperature gauge, and a reflux tube were set therein. The temperature of the reaction liquid was increased with the oil bath until toluene refluxed, followed by complete dissolution of the crude product in toluene. After that, the solution was left standing to cool to room temperature, and the precipitated solid was recovered by filtration under reduced pressure. The recovered solid was dissolved in 100 mL of toluene again, and the same operation was repeated. Thus, 32.7 g of a white solid of methyl diphenolate was obtained.

### Synthesis Example 5 (Synthesis of Polycarbonate Oligomer)

Sodium dithionite (Na₂S₂O₄) was added to 5.6 mass % aqueous sodium hydroxide so that its concentration became 2,000 ppm with respect to bisphenol A (BPA) to be dissolved later. BPA was dissolved therein so that the concentration of BPA became 13.5 mass %. Thus, a solution of BPA in aqueous sodium hydroxide was prepared.

The solution of BPA in aqueous sodium hydroxide, methylene chloride, and phosgene were continuously passed through a tubular reactor having an inner diameter of 6 mm and a tube length of 30 m at flow rates of 40 L/hr, 13 L/hr, and 4.5 kg/hr, respectively. The tubular reactor had a jacket portion and the temperature of the reaction liquid was kept at 40° C. or less by passing cooling water through the jacket. An aqueous phase was separated and removed by continuously taking the reaction liquid out of the tubular reactor and leaving the reaction liquid at rest. Then, a methylene chloride phase was collected.

The solution of a polycarbonate oligomer (PCO) in methylene chloride (PCO solution (a)) thus obtained had a concentration of 301 g/L and a chloroformate group concentration of 1.03 mol/L.

### Production Example 1 (Synthesis of Aromatic Polycarbonate-Based Resin (PC-1) [BPA-Cyclohexyl Diphenolate Copolymer])

255 Milliliters of the solution of the polycarbonate oligomer produced in Synthesis Example 5, 495 mL of methylene chloride, 21.2 g of cyclohexyl diphenolate produced in Synthesis Example 1 described above, and 178 μL of triethylamine (TEA) were loaded into a 1-liter separable flask including a baffle board. Aqueous sodium hydroxide (obtained by dissolving 3.3 g of sodium hydroxide in 38.1 mL of pure water) was added to the flask under stirring, and the mixture was subjected to a reaction for 20 minutes to provide a polymerization liquid.

A solution of p-tert-butylphenol (PTBP) in methylene chloride (obtained by dissolving 1.84 g of PTBP in 13 mL of methylene chloride) and a solution of BPA in aqueous sodium hydroxide (obtained by dissolving 17.9 g of BPA in an aqueous solution obtained by dissolving 9.9 g of sodium hydroxide and 36 mg of sodium dithionite in 145 mL of pure water) were added to the polymerization liquid, and the mixture was subjected to a polymerization reaction for 40 minutes.

100 Milliliters of methylene chloride was added for diluting the reaction liquid, and the mixture was stirred for 10 minutes. After that, the mixture was separated into an organic phase containing an aromatic polycarbonate-based resin (PC-1), and an aqueous phase containing excess amounts of BPA and sodium hydroxide, and the organic phase was isolated. The solution of the aromatic polycarbonate-based resin (PC-1) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the aromatic polycarbonate-based resin (PC-1) was obtained as a white product. The aromatic polycarbonate-based resin (PC-1) had a content of the structural unit represented by the formula (II) of 21.3 mass % and a viscosity-average molecular weight (Mv) of 22,100.

### Production Example 2 (Synthesis of Aromatic Polycarbonate-Based Resin (PC-2) [BPA-Cyclohexyl 2,2-Bis(4-hydroxyphenyl)propanoate Copolymer])

58 Milliliters of the solution of the polycarbonate oligomer produced in Synthesis Example 5, 19 mL of methylene chloride, 4.15 g of cyclohexyl 2,2-bis(4-hydroxyphenyl) propanoate produced in Synthesis Example 3 described above, and 41 μL of triethylamine (TEA) were loaded into a 300-milliliter separable flask including a baffle board. Aqueous sodium hydroxide (obtained by dissolving 0.9 g of sodium hydroxide in 9.8 mL of pure water) was added to the flask under stirring, and the mixture was subjected to a reaction for 20 minutes to provide a polymerization liquid.

A solution of p-tert-butylphenol (PTBP) in methylene chloride (obtained by dissolving 0.34 g of PTBP in 2.4 mL of methylene chloride) and a solution of BPA in aqueous sodium hydroxide (obtained by dissolving 4.5 g of BPA in an aqueous solution obtained by dissolving 2.2 g of sodium hydroxide and 9 mg of sodium dithionite in 32 mL of pure water) were added to the polymerization liquid, and the mixture was subjected to a polymerization reaction for 40 minutes.

105 Milliliters of methylene chloride was added for diluting the reaction liquid, and the mixture was stirred for 10 minutes. After that, the mixture was separated into an organic phase containing an aromatic polycarbonate-based resin (PC-2), and an aqueous phase containing excess amounts of BPA and sodium hydroxide, and the organic phase was isolated. The solution of the aromatic polycarbonate-based resin (PC-2) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the aromatic polycarbonate-based resin (PC-2) was obtained as a white product. The aromatic polycarbonate-based resin (PC-2) had a content of the structural unit represented by the formula (II) of 23.0 mass % and a viscosity-average molecular weight (Mv) of 22,300.

### Production Example 3 (Synthesis of Aromatic Polycarbonate-Based Resin (PC-3) [BPA-Cyclopentyl Diphenolate Copolymer])

58 Milliliters of the solution of the polycarbonate oligomer produced in Synthesis Example 5, 19 mL of methylene chloride, 4.1 g of cyclopentyl diphenolate produced in Synthesis Example 2 described above, and 41 μL of triethylamine (TEA) were loaded into a 300-milliliter separable flask including a baffle board. Aqueous sodium hydroxide (obtained by dissolving 0.8 g of sodium hydroxide in 8.7 mL of pure water) was added to the flask under stirring, and the mixture was subjected to a reaction for 20 minutes to provide a polymerization liquid.

A solution of p-tert-butylphenol (PTBP) in methylene chloride (obtained by dissolving 0.34 g of PTBP in 2.4 mL of methylene chloride) and a solution of BPA in aqueous sodium hydroxide (obtained by dissolving 4.3 g of BPA in an aqueous solution obtained by dissolving 2.3 g of sodium hydroxide and 9 mg of sodium dithionite in 33 mL of pure water) were added to the polymerization liquid, and the mixture was subjected to a polymerization reaction for 40 minutes.

100 Milliliters of methylene chloride was added for diluting the reaction liquid, and the mixture was stirred for 10 minutes. After that, the mixture was separated into an organic phase containing an aromatic polycarbonate-based resin (PC-3), and an aqueous phase containing excess amounts of BPA and sodium hydroxide, and the organic phase was isolated. The solution of the aromatic polycarbonate-based resin (PC-3) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the aromatic polycarbonate-based resin (PC-3) was obtained as a white product. The aromatic polycarbonate-based resin (PC-3) had a content of the structural unit represented by the formula (II) of 21.8 mass % and a viscosity-average molecular weight (Mv) of 24,500.

### Production Example 4 (Synthesis of Aromatic Polycarbonate-Based Resin (PC-4) [BPA-Methyl Diphenolate])

42 Milliliters of the solution of the polycarbonate oligomer produced in Synthesis Example 5, 58 mL of methylene chloride, 0.24 g of p-tert-butylphenol (PTBP), 2.9 g of methyl diphenolate produced in Synthesis Example 4 described above, and 29 μL of triethylamine (TEA) were loaded into a 300-milliliter separable flask including a baffle board. Aqueous sodium hydroxide (obtained by dissolving 0.5 g of sodium hydroxide in 6.2 mL of pure water) was added to the flask under stirring, and the mixture was subjected to a reaction for 20 minutes to provide a polymerization liquid.

A solution of BPA in aqueous sodium hydroxide (obtained by dissolving 3.1 g of BPA in an aqueous solution obtained by dissolving 1.6 g of sodium hydroxide and 6 mg of sodium dithionite in 24 mL of pure water) was added to the polymerization liquid, and the mixture was subjected to a polymerization reaction for 40 minutes.

50 Milliliters of methylene chloride was added for diluting the reaction liquid, and the mixture was stirred for 10 minutes. After that, the mixture was separated into an organic phase containing an aromatic polycarbonate-based resin (PC-4), and an aqueous phase containing excess amounts of BPA and sodium hydroxide, and the organic phase was isolated. The solution of the aromatic polycarbonate-based resin (PC-4) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 μS/cm or less. The washed organic phase was turned into a flake by evaporating its solvent with an evaporator. Thus, the aromatic polycarbonate-based resin (PC-4) was obtained as a white product. The aromatic polycarbonate-based resin (PC-4) had a content of the structural unit represented by the formula (II) of 19.4 mass % and a viscosity-average molecular weight (Mv) of 21,400.

### Examples 1 to 10 and Comparative Examples 1 to 9

As shown in Table 1, each of the aromatic polycarbonate-based resins (PC-1) to (PC-4) and an aromatic polycarbonate-based resin “TARFLON FN2200” (product name, manufactured by Idemitsu Kosan Co., Ltd., aromatic polycarbonate-based resin formed of BPA, viscosity-average molecular weight Mv: 21,700), and any one of a UV absorber, a flame retardant, a polystyrene-based resin, a polyester-based resin, and an inorganic filler were mixed. Each of the mixtures was supplied to a vented twin-screw extruder (manufactured by DSM

Xplore, Micro 15cc Twin Screw Compounder), and was melt-kneaded at a screw revolution number of from 50 rpm to 60 rpm, an ejection amount of 20 kg/hr, and a resin temperature of from 270° C. to 295° C. Thus, evaluation pellet samples of polycarbonate-based resin compositions 1 to 10 and 21 to 29 were obtained.

### (Evaluation of Scratch Hardness (Pencil Method))

The polycarbonate-based resin compositions 1 to 10 and 21 to 29 obtained in the foregoing were each subjected to injection molding with an injection molding machine (“Mini Jet Pro” manufactured by Thermo Fisher Scientific, Inc.) under the conditions of a cylinder temperature of from 275° C. to 300° C. and a mold temperature of from 110° C. to 120° C. to produce a disc-shaped molded article (having a diameter of 30 mm and a thickness of 1.5 mm).

A line was drawn on the basis of JIS K 5600 May 4:1999 with a pencil under a state in which a load of 750 g was applied to the pencil while an angle of 45° was kept. The presence or absence of a scratch on the surface was visually inspected, and the scratch hardness (pencil method) was evaluated. A pencil hardness determined by the scratch hardness (pencil method) is a pencil hardness on any one of the following 14 stages: 6B to B, HB, F, and H to 6H. The results are shown in Table 1.

TABLE 1

| | | Example | Example | Example | Example | Example |
|---|---|---|---|---|---|---|
| | | 1 | 2 | 3 | 4 | 5 |
| Polycarbonate-based resin | | 1 | 2 | 3 | 4 | 5 |
| composition | | | | | | |
| Aromatic | PC-1 | 100 | 100 | 100 | 90 | 90 |
| polycarbonate- | PC-2 | — | — | — | — | — |
| based resin | PC-3 | — | — | — | — | — |
| | PC-4 | — | — | — | — | — |
| | FN*¹ | — | — | — | — | — |
| UV absorber | LA-31*² | 0.3 | — | — | — | — |
| Flame retardant | KFBS*³ | — | 0.05 | — | — | — |
| | PX-200*⁴ | — | — | 10 | — | — |
| Polystyrene- | AT-05*⁵ | — | — | — | 10 | — |
| based resin | S101N*⁶ | — | — | — | — | 10 |
| Polyester-based | J055*⁷ | — | — | — | — | — |
| resin | J125*⁸ | — | — | — | — | — |
| Inorganic filler | GF*⁹ | — | — | — | — | — |
| Scratch hardness | | F | F | F | HB | F |
| | | Example | Example | Example | Example | Example |
| | | 6 | 7 | 8 | 9 | 10 |
| Polycarbonate-based resin | | 6 | 7 | 8 | 9 | 10 |
| composition | | | | | | |
| Aromatic | PC-1 | 80 | 80 | 100 | — | — |
| polycarbonate- | PC-2 | — | — | — | 100 | — |
| based resin | PC-3 | — | — | — | — | 100 |
| | PC-4 | — | — | — | — | — |
| | FN*¹ | — | — | — | — | — |
| UV absorber | LA-31*² | — | — | — | 0.3 | 0.3 |
| Flame retardant | KFBS*³ | — | — | — | — | — |
| | PX-200*⁴ | — | — | — | — | — |
| Polystyrene- | AT-05^{*5} | — | — | — | — | — |
| based resin | S101N*⁶ | — | — | — | — | — |
| Polyester-based | J055*⁷ | 20 | — | — | — | — |
| resin | J125*⁸ | — | 20 | — | — | — |
| Inorganic filler | GF*⁹ | — | — | 10 | — | — |

| | | | | | |
|---|---|---|---|---|---|
| Scratch hardness | F | F | 2H | F | F |

| | | Comparative | Comparative | Comparative | Comparative | Comparative |
|---|---|---|---|---|---|---|
| | | Example | Example | Example | Example | Example |
| | | 1 | 2 | 3 | 4 | 5 |
| Polycarbonate-based resin | | 21 | 22 | 23 | 24 | 25 |
| composition | | | | | | |
| Aromatic | PC-1 | — | — | — | — | — |
| polycarbonate- | PC-2 | — | — | — | — | — |
| based resin | PC-3 | — | — | — | — | — |
| | PC-4 | — | — | — | — | — |
| | FN*¹ | 100 | 100 | 100 | 90 | 90 |
| UV absorber | LA-31*² | 0.3 | — | — | — | — |
| Flame | KFBS*³ | — | 0.05 | — | — | — |
| retardant | PX-200*⁴ | — | — | 10 | — | — |
| Polystyrene- | AT-05*⁵ | — | — | — | 10 | — |
| based resin | S101N*⁶ | — | — | — | — | 10 |
| Polyester- | J055*⁷ | — | — | — | — | — |
| based resin | J125*⁸ | — | — | — | — | — |
| Inorganic filler | GF*⁹ | — | — | — | — | — |

| | | | | | |
|---|---|---|---|---|---|
| Scratch hardness | B | B | HB | B | HB |

| | | Comparative | Comparative | Comparative | Comparative |
|---|---|---|---|---|---|
| | | Example | Example | Example | Example |
| | | 6 | 7 | 8 | 9 |
| Polycarbonate-based resin | | 26 | 27 | 28 | 29 |
| composition | | | | | |
| Aromatic | PC-1 | — | — | — | — |
| polycarbonate- | PC-2 | — | — | — | — |
| based resin | PC-3 | — | — | — | — |
| | PC-4 | — | — | — | 100 |
| | FN*¹ | 80 | 80 | 100 | — |
| UV absorber | LA-31*² | — | — | — | 0.3 |
| Flame | KFBS*³ | — | — | — | — |
| retardant | PX-200*⁴ | — | — | — | — |
| Polystyrene- | AT-05*⁵ | — | — | — | — |
| based resin | S101N*⁶ | — | — | — | — |
| Polyester- | J055*⁷ | 20 | — | — | — |
| based resin | J125*⁸ | — | 20 | — | — |
| Inorganic filler | GF*⁹ | — | — | 10 | — |

| | | | | |
|---|---|---|---|---|
| Scratch hardness | HB | HB | F | HB |

*¹the term “FN” means “TARFLON FN2200” (aromatic polycarbonate-based resin formed of BPA, viscosity-average molecular weight Mv: 21,700) manufactured by Idemitsu Kosan Co., Ltd.
*²the term “LA-31” means “ADK STAB (trademark) LA-31RG” (2,2′-methylenebis[4-(1,1,3,3-tetramethylbutyl)-6-(2H-benzotriazol-2-yl)phenol]) manufactured by ADEKA Corporation.
*³the term “KFBS” means “EFTOP KFBS” (potassium perfluorobutanesulfonate) manufactured by Mitsubishi Materials Corporation.
*⁴the term “PX-200” means “PX-200” (1,3-phenylene-tetrakis(2,6-dimethylphenyl)phosphate) manufactured by Daihachi Chemical Industry Co., Ltd.
*⁵the term “AT-05” means “SANTAC AT-05” (acrylonitrile-butadiene-styrene copolymer) manufactured by Nippon A&L Inc.
*⁶the term “S101N” means “S101N” (acrylonitrile-styrene binary copolymer) manufactured by Techno-UMG Co., Ltd.
*⁷the term “J055” means “MITSUI PET (trademark) J055” (polyethylene terephthalate) manufactured by Mitsui Chemicals, Inc.
*⁸the term “J125” means “MITSUI PET (trademark) J125” (polyethylene terephthalate) manufactured by Mitsui Chemicals, Inc.
*⁹the term “GF” means “T511” (glass fibers) manufactured by Nippon Electric Glass Co., Ltd.

As shown in Table 1, it was found that each of the polycarbonate-based resin compositions 1 to 10 of Examples exhibited excellent scratch hardness and was improved in scratch resistance as compared to each of the polycarbonate-based resin compositions 21 to 29 of Comparative Examples corresponding thereto in terms of any one of the UV absorber, the flame retardant, the polystyrene-based resin, the polyester-based resin, and the inorganic filler included therein.

In addition, the scratch hardness of each of the polycarbonate-based resin compositions 23 and 25 to 28 of Comparative Examples 3 and 5 to 9 showed a satisfactory result of HB or F, but the scratch hardness of each of the corresponding polycarbonate-based resin compositions 3 and 5 to 8 of Examples 3 and 5 to 8 was F or 2H. Accordingly, it is conceived that the scratch hardness of each of the polycarbonate-based resin compositions 23 and 25 to 28 results from the effects of the flame retardant, the polystyrene-based resin, the polyester-based resin, and the inorganic filler rather than the aromatic polycarbonate-based resin.

It was found that the polycarbonate-based resin composition 1 of Example 1 exhibited comparable or excellent scratch hardness and was improved in scratch resistance as compared to the polycarbonate-based resin composition 29 of Comparative Example 9 including the same amount of the UV absorber. In view of the foregoing, it is conceived that the scratch resistance of the polycarbonate-based resin composition including the aromatic polycarbonate-based resin including the structural unit represented by the formula (II) in which R¹⁴ represents a group having a cyclic structure is improved as compared to the scratch resistance of the polycarbonate-based resin composition including the aromatic polycarbonate-based resin including the structural unit represented by the formula (II) in which R¹⁴ represents a group having a chain structure.

1. A polycarbonate-based resin composition, comprising:
an aromatic polycarbonate-based resin comprising a structural unit represented by the following formula (II); and
at least one kind selected from the group consisting of: a UV absorber; a flame retardant; a polystyrene-based resin; a polyester-based resin; and an inorganic filler: 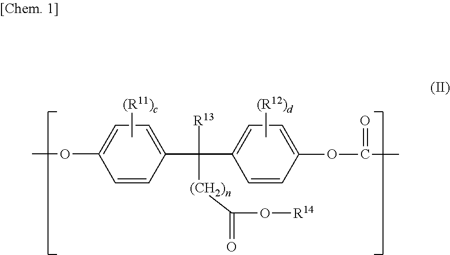
wherein in the formula (II),
R¹¹ and R¹² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
R¹³ represents a hydrogen atom, or a group selected from the group consisting of: an alkyl group having 1 to 5 carbon atoms; a cycloalkyl group having 3 to 20 carbon atoms; a cycloalkoxy group having 3 to 20 carbon atoms; an alkenyl group having 2 to 10 carbon atoms; and an aryl group having 6 to 14 carbon atoms,
R¹⁴ represents a saturated or unsaturated alicyclic group having 3 to 20 carbon atoms, or a 3- to 20-membered saturated or unsaturated heterocyclic group,
“c” and “d” each independently represent an integer of from 0 to 4, and
“n” represents an integer of from 0 to 20.

2. The polycarbonate-based resin composition according to claim 1, wherein R¹⁴ represents a saturated or unsaturated alicyclic group having 3 to 12 carbon atoms, or a 3- to 12-membered saturated or unsaturated heterocyclic group.

3. The polycarbonate-based resin composition according to claim 2, wherein R¹⁴ represents a cyclopentyl group or a cyclohexyl group.

4. The polycarbonate-based resin composition according to claim 1, wherein “n” represents an integer of from 0 to 4.

5. The polycarbonate-based resin composition according to claim 1, wherein the UV absorber comprises at least one kind selected from the group consisting of: a benzotriazole-based UV absorber; a benzoxazinone-based UV absorber; a salicylate-based UV absorber; a malonic acid ester-based UV absorber; an oxalic anilide-based UV absorber; a triazine-based UV absorber; a benzophenone-based UV absorber; and a cyanoacrylate-based UV absorber.

6. The polycarbonate-based resin composition according to claim 1, wherein the flame retardant comprises at least one kind selected from the group consisting of: a phosphorus-based flame retardant; and a metal salt-based flame retardant.

7. The polycarbonate-based resin composition according to claim 1, wherein the polystyrene-based resin comprises at least one kind selected from the group consisting of: a high impact polystyrene resin; an acrylonitrile-styrene copolymer; an acrylonitrile-butadiene-styrene copolymer; a methyl methacrylate-styrene copolymer; a methyl methacrylate-butadiene-styrene copolymer; an acrylonitrile-methyl acrylate-styrene copolymer; and an acrylonitrile-(ethylene/propylene/diene copolymer)-styrene copolymer.

8. The polycarbonate-based resin composition according to claim 1, wherein the polyester-based resin comprises at least one kind selected from the group consisting of: polyethylene terephthalate; polybutylene terephthalate; polyethylene naphthalate; and polybutylene naphthalate.

9. The polycarbonate-based resin composition according to claim 1, wherein the inorganic filler is a glass filler.

10. The polycarbonate-based resin composition according to claim 1, further comprising a repeating unit represented by the following formula (I): 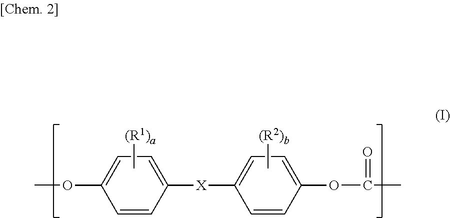
wherein in the formula (I),
R¹ and R² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an aralkyl group having 7 to 20 carbon atoms, —S—, —SO—, —SO₂—, —O—, or —CO—, and
“a” and “b” each independently represent an integer of from 0 to 4.

11. A molded article of the polycarbonate-based resin composition of claim 1.
